(19) United States
(12) Patent Application Publication
(10) Pub. No.: US 2021/0188325 A1
(43) Pub. Date: Jun. 24, 2021

(54) CONTROL DEVICE AND CONTROL METHOD

(71) Applicant: HONDA MOTOR CO., LTD., Tokyo (JP)

(72) Inventor: Koichi Ogura, Tokyo (JP)

(21) Appl. No.: 17/124,529

(22) Filed: Dec. 17, 2020

(30) Foreign Application Priority Data
Dec. 20, 2019 (JP) 2019-230302
Dec. 20, 2019 (JP) 2019-230621

(51) Int. Cl. B60W 60/00; G08G 1/00; G06Q 30/02; G01C 21/34

(52) U.S. Cl. CPC B60W 60/00253; G08G 1/202; G01C 21/3461; G01C 21/3415; G06Q 30/0283

(57) ABSTRACT

Provided is a vehicle control device including: a traveling controller configured to control a speed and steering of a vehicle; a receiver configured to receive a stop request from a user riding in the vehicle; and a searcher configured to search for a first location that is a closest getting on/off location where the user is able to get off, in a case in which the receiver receives the stop request, the traveling controller decelerating the speed of the vehicle, the searcher searching for the first location, and then the traveling controller directing the vehicle to the first location searched for by the searcher.

### CROSS-REFERENCE TO RELATED APPLICATION

Priority is claimed on Japanese Patent Application No. 2019-230302, filed Dec. 20, 2019 and Japanese Patent Application No. 2019-230621, filed Dec. 20, 2019, the contents of which are incorporated herein by reference.

### BACKGROUND

### Field of the Invention

The present invention relates to a control device and a control method.

### Description of Related Art

In recent years, automatic control of vehicles has been studied. In relation to this, techniques in which a near field communication device for unlocking a door of a vehicle dispatched by a vehicle dispatching system is provided near the door and the door is unlocked or opened by the near field communication device authenticating a terminal device used by a user who is about to get on the vehicle have been disclosed in the related art (Japanese Unexamined Patent Application Publication No. 2019-28663, for example).

However, the related art does not take into account a situation in which a user gets off an automatically driven vehicle at a desired location.

In the related art, a vehicle dispatching management server configured to manage vehicle dispatching is known (see Japanese Unexamined Patent Application Publication No. 2019-175491). The vehicle dispatching management server predicts a waiting time corresponding to a vehicle assigned to a received vehicle dispatching request, and in a case in which the predicted waiting time is not within a predetermined range, the vehicle dispatching management server requests the vehicle to pick up the user after a predetermined confirmation.

However, the aforementioned technique does not sufficiently examine the situation after the user gets on the vehicle.

### SUMMARY

The present invention was made in consideration of such circumstances, and one object thereof is to provide a control device and a control method capable of allowing a user to get off an automated driving vehicle at a desired location.

The present invention was made in consideration of such circumstances, and another object thereof is to provide a control device and a control method capable of improving convenience for a user after riding in a vehicle.

A control device and a control method according to the present invention employ the following configurations.

A control device according to a first aspect of the present invention is a control device including: a traveling controller configured to control a speed and steering of a vehicle; a receiver configured to receive a stop request from a user riding in the vehicle; and a searcher configured to search for a first location that is a closest getting on/off location where the user is able to get off the vehicle, based on the stop request, in a case in which the receiver receives a stop request, the traveling controller decelerating the speed of the vehicle, the searcher searching for the first location, and then, the traveling controller directing the vehicle to the first location searched for by the searcher.

According to a second aspect, in the aforementioned first aspect, the searcher searches for a second location that is a getting on/off location other than the first location in a case in which there are no vacancies at the searched first location, and the traveling controller directs the vehicle to the second location searched for by the searcher.

According to a third aspect, in the aforementioned second aspect, the control device further includes: a proposer configured to propose, to the user, a change in stopping location to the second location when the traveling controller is directing the vehicle to the first location in the case in which there are no vacancies at the searched first location.

According to a fourth aspect, in the aforementioned third aspect, the traveling controller directs the vehicle to the second location in a case in which the receiver receives, from the user, a response indicating that the stopping location is to be changed to the second location.

According to a fifth aspect, in the aforementioned third or fourth aspect, the traveling controller directs the vehicle to the second location in a case in which the receiver does not receive, from the user, a response indicating that the stopping location is to be changed to the second location and there are no vacancies at the first location.

According to a sixth aspect, in the aforementioned fifth aspect, the searcher continues to search for the second location until the vehicle arrives at the first location, and in a case in which the vehicle arrives at the first location, the receiver receives, from the user, either a response indicating that the user is to get off the vehicle at the first location or a response indicating that the stopping location is to be changed to the second location.

According to a seventh aspect, in any of the aforementioned first to sixth aspects, the control device further includes: a door controller configured to control at least opening of a door of the vehicle based on a result of an operation performed by the user on a manipulator, the manipulator is the same as a manipulator through which the receiver receives the stop request, and in a case in which the vehicle arrives at the stopping location and the receiver receives an operation indicating that the user is to get off the vehicle performed by the user on the manipulator, the door controller opens the door of the vehicle.

According to an eighth aspect, in the aforementioned first aspect, the door controller further controls closing of the door of the vehicle, and in a case in which the receiver receives an operation performed by the user on the manipulator in a state in which the door is opened, the door controller closes the door of the vehicle.

According to a ninth aspect, in the aforementioned seventh or eighth aspect, the manipulator is one or more electronic switches provided in the vehicle and configured to receive a response regarding the stopping location and an operation regarding opening/closing of the door from the user, a mechanical door handle configured to receive a manual door opening operation performed by the user is included in the manipulator, and the door controller controls opening of the door of the vehicle based on the operation performed by the user on the switch.

A control method according to a tenth aspect of the present invention is a control method including, by a computer: controlling a speed and steering of a vehicle; receiving a stop request from a user riding in the vehicle; searching for a first location that is a closest getting on/off location where the user is able to get off the vehicle based on the stop request; and in a case in which the stop request is received, decelerating the speed of the vehicle and searching for the first location; and directing the vehicle to the searched first location.

A non-transitory computer readable storage medium according to an eleventh aspect of the present invention is a non-transitory computer readable storage medium that stores a program that causes a computer to: control a speed and steering of a vehicle; receive a stop request from a user riding in the vehicle; search for a first location that is a closest getting on/off location where the user is able to get off the vehicle based on the stop request; and in a case in which the stop request is received, decelerate the speed of the vehicle and searching for the first location; and direct the vehicle to the searched first location.

A control device according to a twelfth aspect of the present invention includes: a first acquirer configured to acquire destination information indicating a destination of a user from a terminal device that the user is able to operate; a first processor configured to direct the vehicle with the user riding therein to the destination; a second acquirer configured to acquire, from a terminal device that the user is able to operate, getting-off request information for a request for getting off the vehicle before the vehicle arrives at the destination; and a second processor configured to stop the vehicle before the vehicle arrives at the destination based on the getting-off request information in a case in which the second acquirer acquires the getting-off request information.

According to a thirteenth aspect, in the aforementioned twelfth aspect, the terminal device that the user is able to operate is a terminal device that the user brings with himself/herself or a terminal device provided in the vehicle.

According to a fourteenth aspect, in the aforementioned twelfth or thirteenth aspect, in a case in which the user gets off the vehicle at the destination or before the vehicle arrives at the destination, the second processor controls the vehicle such that a service for the user is provided and a service to a user different from the user is provided.

According to the fifteenth aspect, in any of the aforementioned twelfth to fourteenth aspects, the control device further includes: a third acquirer configured to acquire, from the terminal device that the user is able to operate, booking information for booking the user's reboarding of the vehicle after the user gets off the vehicle before the vehicle arrives at the destination; and a third processor configured to control the vehicle based on the booking information acquired by the third acquirer.

According to a sixteenth aspect, in the aforementioned fourteenth aspect, the third processor dispatches a vehicle that is different from the vehicle in which the user has ridden, based on the booking information.

According to a seventeenth aspect, in any of the aforementioned twelfth to fifteenth aspects, the control device further includes: a third acquirer configured to acquire, from the terminal device that the user is able to operate, urgent getting-off request information for an urgent getting-off instruction from the user; and a third processor configured to cause the vehicle with the user riding therein to stop at a specific location associated with the urgent instruction information acquired by the third acquirer.

According to the eighteenth aspect, in any of the aforementioned twelfth to sixteenth aspects, the control device further includes: a charger configured to charge the user for riding in the vehicle based on preset criteria in a case in which the user rides in the vehicle, and in a case in which the user gets off the vehicle before the vehicle arrives at the destination, the charger does not charge the user for any fee for the getting-off.

Provided is a control method causing a computer according to a nineteenth aspect to: acquire destination information indicating a destination of a user from a terminal device that the user is able to operate; direct a vehicle with the user riding therein to the destination; acquire getting-off request information for a request for getting-off the vehicle before the vehicle arrives at the destination from a terminal device that the user is able to operate; and in a case in which the getting-off request information is acquired, cause the vehicle to stop before the vehicle arrives at the destination based on the getting-off request information.

A non-transitory computer readable storage medium according to an twenty aspect is a non-transitory computer readable storage medium that stores a program to cause a computer to execute processes of: acquiring destination information indicating a destination of a user from a terminal device that the user is able to operate; directing a vehicle with the user riding therein to the destination; acquiring getting-off request information for a request for getting-off the vehicle before the vehicle arrives at the destination from a terminal device that the user is able to operate; and in a case in which the getting-off request information is acquired, causing the vehicle to stop before the vehicle arrives at the destination based on the getting-off request information.

According to the first to eleventh aspects, it is possible to allow the user to get off an automated driving vehicle at a desired location.

According to the first to ninth aspects, it is possible to control opening of the door of the vehicle such that it opens at a suitable timing.

According to the eighth aspect, it is possible to control closing of the door of the vehicle at a suitable timing.

According to the twelfth to eighteenth aspects, it is possible to improve convenience for the user after the user gets on the vehicle by the control device causing the vehicle to stop before arriving at the destination based on the getting-off request information.

According to the thirteenth aspect, it is possible for the user to transmit the getting-off request information to the control device to get off the vehicle at a getting-off position with a simple operation.

According to the fourteenth aspect, the control device can simplify the process for completing the service to the user and providing a service to a user who is different from the user in the case in which the user gets off the vehicle at the destination or before the vehicle arrives at the destination and can allow the next user to get on the vehicle without waiting for the user who has gotten off the vehicle, and utilization efficiency of the vehicle is thus improved.

According to the fifteenth aspect, the control device accepts reboarding of the user, and convenience for the user is thus improved.

According to the sixteenth aspect, the control device can allow the user to take another vehicle at the time of the reboarding, and convenience for the user is thus improved. Since the control device dispatches another vehicle without waiting for the user who has gotten off the vehicle, it is possible to more efficiently dispatch a vehicle.

According to the seventeenth aspect, the control device automatically directs the vehicle to a specific location (a hospital, for example) in a case in which the user is in a poor physical health, and the user can thus use the vehicle by himself/herself with peace of mind.

According to the eighteenth aspect, in a case in which the user gets off the vehicle before arriving at the destination, the control device does not charge the user for any fee for the getting-off, and the user can thus casually use the vehicle.

### BRIEF DESCRIPTION OF THE DRAWINGS

FIG. 1 is a configuration diagram of a vehicle system.

FIG. 2 is a functional configuration diagram of a first controller and a second controller.

FIG. 3 is a configuration diagram of a vehicle control device.

FIG. 4 is an example of information stored in stopping location information.

FIG. 5 is a diagram for explaining a disposition example of a manipulator.

FIG. 6 is a diagram for explaining a disposition example of the manipulator in a door.

FIG. 7 is an example of information stored in manipulator information.

FIG. 8 is a diagram for explaining a first scene.

FIG. 9 is a diagram for explaining a second scene.

FIG. 10 is a diagram for explaining a third scene.

FIG. 11 is a flowchart showing an example of a flow of a process performed by the vehicle control device when a user gets off the vehicle.

FIG. 12 is a flowchart showing an example of a flow of a process performed by the vehicle control device when the user gets off the vehicle.

FIG. 13 is a diagram showing an example of a hardware configuration of a vehicle control device according to a first embodiment.

FIG. 14 is a diagram showing an example of a vehicle system configuration using the control device.

FIG. 15 is a diagram for explaining an overview of a process executed by the vehicle system.

FIG. 16 is a diagram showing an example of a functional configuration of a terminal device.

FIG. 17 is a diagram showing an example of a functional configuration of a management device.

FIG. 18 is a sequence diagram showing an example of a flow of a process executed by the vehicle system.

FIG. 19 is a diagram showing an example of an image displayed by a service application on a touch panel of the terminal device.

FIG. 20 is a flowchart showing an example of a flow of a process executed by the management device.

FIG. 21 is a diagram showing an example of details of POI information.

FIG. 22 is a diagram showing an example of an image indicating a getting-off position displayed on the touch panel.

FIG. 23 is a sequence diagram showing an example of a flow of a process executed by the vehicle system.

FIG. 24 is a diagram showing an example of a trend of a charged fee for usage.

FIG. 25 is a diagram showing an example of details of POI information.

FIG. 26 is a diagram showing an example of a condition of the interior of the vehicle.

### DETAILED DESCRIPTION

Hereinafter, embodiments of a control device and a control method according to the present invention will be described with reference to the drawings. As used throughout this disclosure, the singular forms “a,” “an,” and “the” include plural reference unless the context clearly dictates otherwise.

### First Embodiment

### Overall Configuration

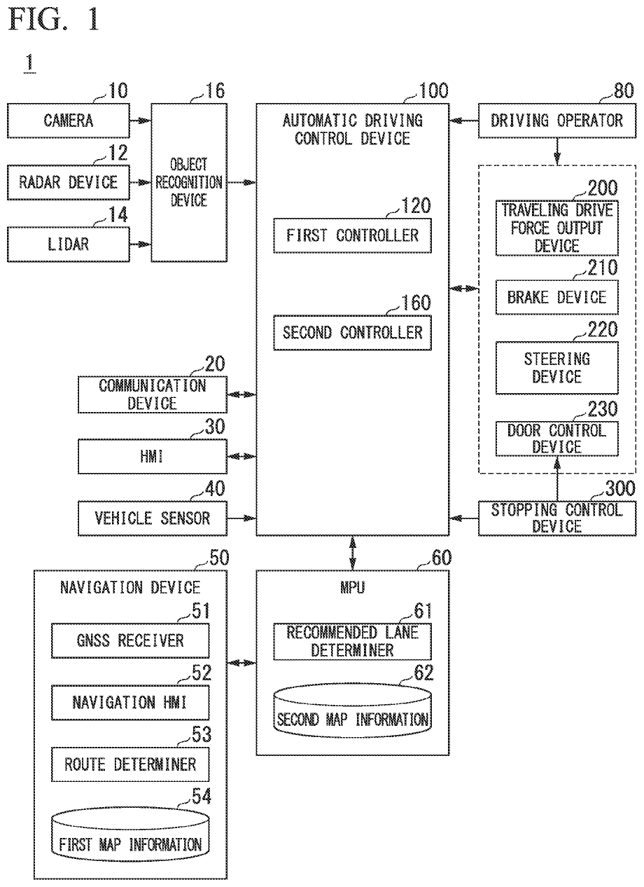

FIG. 1 is a configuration diagram of a vehicle system 1 using a vehicle control device (control device) according to a first embodiment. A vehicle in which the vehicle system 1 is mounted is, for example, a vehicle with two wheels, three wheels, four wheels, or the like, and a drive source thereof is an internal combustion engine such as a diesel engine or a gasoline engine, a motor, or a combination thereof. The motor operates using electric power generated by a generator coupled to the internal combustion engine or electric power discharged by a secondary cell or a fuel cell.

The vehicle system 1 includes, for example, a camera 10, a radar device 12, a light detection and ranging (LIDAR) device 14, an object recognition device 16, a communication device 20, a human machine interface (HMI) 30, a vehicle sensor 40, a navigation device 50, a map positioning unit (MPU) 60, a driving operator 80, an automatic driving control device 100, a traveling drive force output device 200, a brake device 210, a steering device 220, a door control device 230, and a vehicle control device 300. These devices and equipment are connected to each other through a multiplex communication line such as a controller area network (CAN) communication line, a serial communication line, a wireless communication network, or the like. The configuration shown in FIG. 1 is just an example, and a part of the configuration may be omitted, or other constituents may further be added thereto.

The camera 10 is a digital camera using a solid image pick-up device such as a charge coupled device (CCD) or a complementary metal oxide semiconductor (CMOS). The camera 10 is attached to an arbitrary location in the vehicle (hereinafter, referred to as a vehicle M) in which the vehicle system 1 is mounted. In a case in which a front is imaged, the camera 10 is attached to an upper portion of a front windshield, a rear surface of an interior mirror, or the like. The camera 10 periodically and repeatedly images the surroundings of the vehicle M. The camera 10 may be a stereo camera.

The radar device 12 emits electromagnetic waves such as millimeter waves to the surroundings of the vehicle M and detects electromagnetic waves (reflected waves) reflected by objects, thereby detecting at least positions (distances and azimuths) of the objects. The radar device 12 is attached to an arbitrary location in the vehicle M. The radar device 12 may detect positions and speeds of objects by a frequency modulated continuous wave (FM-CW) scheme.

The LIDAR 14 emits light (or electromagnetic waves with wavelengths close to light) to the surroundings of the vehicle M and measures scattered light. The LIDAR 14 detects distances to targets on the basis of time from light emission to light reception. The emitted light is, for example, pulsed laser light. The LIDAR 14 is attached to an arbitrary location in the vehicle M.

The object recognition device 16 performs a sensor fusion process on detection results obtained by some or all of the camera 10, the radar device 12, and the LIDAR 14 to recognize positions, types, speeds, and the like of the objects. The object recognition device 16 outputs the results of the recognition to the automatic driving control device 100. The object recognition device 16 may output the results of detection of the camera 10, the radar device 12, and the LIDAR 14 directly to the automatic driving control device 100. The object recognition device 16 may be omitted from the vehicle system 1.

The communication device 20 communicates with other vehicles that are present in the surroundings of the vehicle M using a cellular network, a Wi-Fi network, Bluetooth (registered trademark), or dedicated short range communication (DSRC), for example, or communicates with various server devices via a wireless base station.

The HMI 30 presents various kinds of information to passengers in the vehicle M and receives input operations performed by the passengers. The HMI 30 includes various display devices, a speaker, a buzzer, a touch panel, a switch, a key, and the like.

The vehicle sensor 40 includes a vehicle speed sensor configured to detect a speed of the vehicle M, an acceleration sensor configured to detect an acceleration, a yaw rate sensor configured to detect an angular speed around a vertical axis, an azimuth sensor configured to detect an orientation of the vehicle M, and the like.

The navigation device 50 includes, for example, a global navigation satellite system (GNSS) receiver 51, a navigation HMI 52, a route determiner 53. The navigation device 50 holds first map information 54 in a storage device such as a hard disk drive (HDD) or a flash memory. The GNSS receiver 51 specifies the position of the vehicle M on the basis of a signal received from a GNSS satellite. The position of the vehicle M may be specified or complemented by an inertial navigation system (INS) using outputs from the vehicle sensor 40. The navigation HMI 52 includes a display device, a speaker, a touch panel, a key, and the like. Part or the entirety of the navigation HMI 52 may be shared with the aforementioned HMI 30. The route determiner 53 determines a route from the position of the vehicle M specified by the GNSS receiver 51 (or an input arbitrary position) to a destination input by a passenger using the navigation HMI 52 (hereinafter, referred to as a route on the map), for example, with reference to the first map information 54. The first map information 54 is information representing road shapes using links representing roads and nodes connected by the links, for example. The first map information 54 may include road curvatures, point of interest (POI) information, and the like. The route on the map is output to the MPU 60. The navigation device 50 may perform route guide using the navigation HMI 52 on the basis of the route on the map. The navigation device 50 may be implemented by functions of a terminal device such as a smartphone or a tablet terminal owned by a passenger, for example. The navigation device 50 may transmit the current position and the destination to a navigation server via the communication device 20 and acquire a route that is equivalent to the route on the map from the navigation server.

The MPU 60 includes, for example, a recommended lane determiner 61 and holds second map information 62 in a storage device such as an HDD or a flash memory. The recommended lane determiner 61 divides the route on the map provided by the navigation device 50 into a plurality of blocks (divides every 100 [m] in a vehicle traveling direction, for example) and determines a recommended lane for each block with reference to the second map information 62. The recommended lane determiner 61 determines the lane numbered from the left side on which the vehicle is to travel. In a case in which a branching point is present in the route on the map, the recommended lane determiner 61 determines a recommended lane such that the vehicle M can travel on a reasonable route to advance after the branching point.

The second map information 62 is map information with a higher accuracy than the first map information 54. The second map information 62 includes, for example, lane center information, lane boundary information, and the like. The second map information 62 may include road information, traffic restriction information, address information (addresses and postal codes), facility information, telephone number information, and the like. The second map information 62 may be updated at any time by the communication device 20 communicating with other devices.

The driving operator 80 includes, for example, an accelerator pedal, a brake pedal, a shift lever, a steering wheel, a variant steering, a joystick, and other operators. A sensor configured to detect the amount of operation or whether operations have been performed is attached to the driving operator 80, and results of the detection are output to the automatic driving control device 100 or some or all of the traveling drive force output device 200, the brake device 210, and the steering device 220.

The automatic driving control device 100 includes, for example, a first controller 120 and a second controller 160. Each of the first controller 120 and the second controller 160 is implemented by a hardware processor such as a central processing unit (CPU) executing a program (software), for example. Some or all of these components may be implemented by hardware (circuit units; including circuitries) such as a large scale integration (LSI), an application specific integrated circuit (ASIC), a field-programmable gate array (FPGA), or a graphics processing unit (GPU) or may be implemented by cooperation of software and hardware. The program may be stored in advance in a storage device (a storage device including a non-transitory storage medium) such as an HDD or a flash memory of the automatic driving control device 100, may be stored in a detachable storage medium such as a DVD or a CD-ROM, or may be installed in the HDD or the flash memory of the automatic driving control device 100 by a storage medium (non-transitory storage medium) being attached to the drive device. The automatic driving control device 100 is an example of the “control device”, and a set of an action plan generator 140 and the second controller 160 is an example of the “driving controller”.

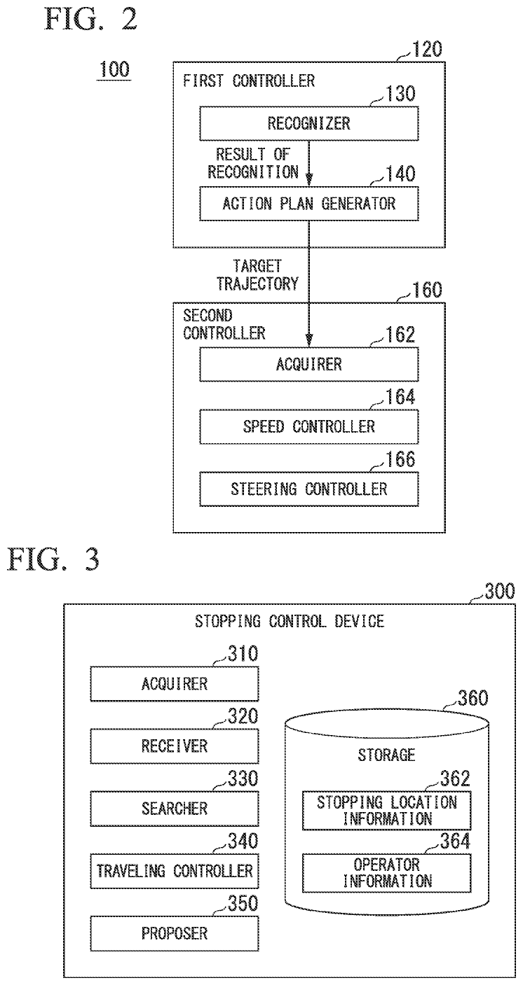

FIG. 2 is a functional configuration diagram of the first controller 120 and the second controller 160. The first controller 120 includes, for example, a recognizer 130 and the action plan generator 140. The first controller 120 realizes, for example, a function of an artificial intelligence (AI) and a function of a model provided in advance in parallel. For example, a function of “recognizing an intersection” may be implemented by executing recognition of an intersection through deep learning or the like and recognition based on conditions provided in advance (a signal that can be pattern-matched, presence of a road sign, or the like) in parallel, scoring both the types of recognition, and comprehensively evaluating the recognition. In this manner, reliability of automatic driving is secured.

The recognizer 130 recognizes states, such as positions, speeds, and accelerations of objects that are present in the surroundings of the vehicle M on the basis of information input from the camera 10, the radar device 12, and the lidar 14 via the object recognition device 16. Positions of objects are recognized as positions on an absolute coordinate systems including a representative point (a center of gravity, a drive axis center, or the like) of the vehicle M as an origin, for example, and are used for control. The positions of objects may be represented using representative points such as centers of gravity, corners, or the like of the objects or may be represented by representative regions. “States” of objects may include accelerations and jerks of the objects or “action states” (for example, whether or not lane change has been performed or is about to be performed).

The recognizer 130 recognizes a lane (traveling lane) on which the vehicle M is traveling, for example. For example, the recognizer 130 recognizes the traveling lane through comparison between a road lane markings pattern (for example, an alignment of solid lines and dashed lines) obtained from the second map information 62 and a road division line pattern in the surroundings of the vehicle M recognized from an image captured by the camera 10. The recognizer 130 may recognize the traveling lane by recognizing not only the road division line but also traveling road boundaries (road boundaries) including the road division line, a road shoulder, a curbstone, a medial divider, a guard rail, and the like. In the recognition, the position of the vehicle M acquired from the navigation device 50 and results of a process performed by the INS may be taken into account. The recognizer 130 recognizes a momentary stop line, a barrier, a red light, a toll gate, and other road features.

The recognizer 130 recognizes the position and the posture of the vehicle M with respect to the traveling lane when the recognizer 130 recognizes the traveling lane. The recognizer 130 may recognize, as the relative position and the posture of the vehicle M with respect to the traveling lane, a distance of a reference point in the vehicle M from the lane center and an angle of the traveling direction of the vehicle M with respect to the line obtained by connecting lane centers, for example. Instead, the recognizer 130 may recognize, as the relative position of the vehicle M with respect to the traveling lane, the position or the like of the reference point of the vehicle M with respect to a side end (a road division line or a road boundary) of the traveling lane on any side.

The action plan generator 140 generates a target trajectory through which the vehicle M is to travel automatically (with no need of driver's operations) in the future such that the vehicle M travels on the recommended lanes determined by the recommended lane determiner 61 in principle and further so as to address surrounding conditions of the vehicle M. The target trajectory includes, for example, a speed element. For example, the target trajectory is expressed as points (trajectory points) that the vehicle M is to reach aligned in order. The trajectory points are points that the vehicle M is to reach at each of predetermined traveling distances (every several [m], for example) with respect to distance along the road, and separately, a target speed and a target acceleration for each predetermined sampling time (every several fractions of a [sec], for example) are generated as parts of the target trajectory. The trajectory points may be positions that the vehicle M is to reach at a sampling clock time for each predetermined sampling time. In this case, information regarding the target speed and the target acceleration is expressed as intervals between the trajectory points.

The action plan generator 140 may set events for automatic driving for generating the target trajectory. The events for automatic driving include a constant speed event, low-speed following traveling event, a lane changing event, a branching event, a joining event, a takeover event, a stopping event, and the like. The action plan generator 140 generates the target trajectory in accordance with activated events.

The second controller 160 controls the traveling drive force output device 200, the brake device 210, and the steering device 220 such that the vehicle M passes through the target trajectory generated by the action plan generator 140 at a clock time as scheduled.

Returning to FIG. 2, the second controller 160 includes, for example, an acquirer 162, a speed controller 164, and a steering controller 166. The acquirer 162 acquires information regarding the target trajectory (trajectory points) generated by the action plan generator 140 and causes a memory (not shown) to store the information. The speed controller 164 controls the traveling drive force output device 200 or the brake device 210 on the basis of a speed element that accompanies the target trajectory stored in the memory. The steering controller 166 controls the steering device 220 in accordance with a curving degree of the target trajectory stored in the memory. The processes of the speed controller 164 and the steering controller 166 are implemented by a combination of feed-forward control and feedback control, for example. In one example, the steering controller 166 executes feed-forward control in accordance with a curvature of a road in front of the vehicle M and feedback control based on separation from the target trajectory in combination.

The traveling drive force output device 200 outputs a traveling drive force (torque) for the vehicle to travel to a drive wheel. The traveling drive force output device 200 includes, for example, a combination of an internal combustion engine, a motor, a transmission and the like and an electronic controller (ECU) that controls them. The ECU controls the aforementioned configurations in accordance with information input from the second controller 160 or information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with information input from the second controller 160 or information input from the driving operator 80 such that a brake torque in accordance with a brake operation is output to each wheel. The brake device 210 may include, as backup, a mechanism configured to transmit the hydraulic pressure generated through an operation of the brake pedal included in the driving operator 80 to the cylinder via a master cylinder. The brake device 210 is not limited to the configuration as described above and may be an electronic control-type hydraulic brake device configured to control an actuator in accordance with information input from the second controller 160 and transmit a hydraulic pressure of the master cylinder to the cylinder.

The steering device 220 includes, for example, a steering ECU and an electric motor. The electric motor causes a force to act on a rack-and-pinion mechanism, for example, to change orientation of a turning wheel. The steering ECU drives the electric motor to change the orientation of the turning wheel in accordance with information input from the second controller 160 or information input from the driving operator 80.

The door control device 230 controls opening and closing of the door of the vehicle M on the basis of a result of an operation received by a manipulator, which will be described later. The door control device 230 is an example of the “door controller”.

FIG. 3 is a configuration diagram of the vehicle control device 300. The vehicle control device 300 includes, for example, an acquirer 310, a receiver 320, a searcher 330, a traveling controller 340, a proposer 350, and a storage 360.

The acquirer 310 acquires an operation signal from the manipulator. The manipulator is a member operated when a user expresses his/her intention to get off the vehicle when the user rides in the vehicle M, such as a press button switch, a sensor button, a microphone, or a touch panel, for example. The manipulator is disposed near each door or each seat such that one or more manipulators can be used by one user. The manipulator may also have the functions of the HMI 30, or a terminal device such as a smartphone that the user uses may be used instead.

The acquirer 310 acquires results of control performed by various devices such as the automatic driving control device 100.

The receiver 320 receives a stop request from a user who rides in the vehicle. The receiver 320 refers to manipulator information 364 stored in the storage 360, for example, and determines whether or not the operation signal of the manipulator acquired by the acquirer 310 corresponds to a stop request. The manipulator information 364 will be described later.

The receiver 320 receives a response from the user in a case in which information of a result of searching performed by the searcher 330 and a result of proposal performed by the proposer 350, which will be described later, is provided to the user. In a case in which the vehicle M arrives at a getting on/off location, for example, the receiver 320 receives either a response indicating that the user is to get off the vehicle at the getting on/off location or a response indicating that a stopping location is to be changed to another getting on/off location.

In a case in which the receiver 320 receives a stop request, the searcher 330 searches for a closest getting on/off location where the user can get off the vehicle, on the basis of the stop request. The getting on/off location is, for example, a getting on/off dedicated facility such as a rotary or a platform, a road rest stop, a parking space for shop users, or a parking space at a road shoulder. In the following description, the closest getting on/off location may be referred to as a “first location”.

The searcher 330 searches for candidates of the closest getting on/off location with reference to a result of a process performed by the navigation device 50, which has been acquired by the acquirer 310, for example. Further, the searcher 330 searches for the first location on the basis of acquired results such as a result of image capturing performed by the camera 10, a recognition result of the surroundings of other vehicles acquired via the acquirer 310, and a vacancy information of the getting on/off location. The searcher 330 provides the information regarding the first location to the user via the HMI 30.

In a case in which there are no vacancies at the first location, the searcher 330 searches for a getting on/off location other than the first location (hereinafter, referred to as a “second location”). In a case in which there are a plurality of candidates of the second location, the searcher 330 may set a location closest to the vehicle M to the second location or may provide information regarding the plurality of candidates as second locations to the user.

The searcher 330 continues to search for the second location until the vehicle M arrives at the first location and the user gets off the vehicle unless an operation indicating that no more searching is needed is received from the user.

In a case in which the receiver 320 receives a stop request, the traveling controller 340 decelerates the speed of the vehicle M such that the vehicle M can stop. In the case in which the receiver 320 receives the stop request, the traveling controller 340 causes the action plan generator 140 to activate a stopping event, causes the vehicle M to travel at a low speed, and directs the vehicle M to the first location. The deceleration of the vehicle M and the searching for the first location may be started at the same time, or any one of them may be started first. However, in the latter case, the deceleration and the searching are preferably started with such a time difference that can be regarded as substantially the same time in order to realize smooth control. It is a matter of course that the directing of the vehicle M to the first location is performed after the searching for the first location is completed.

In a case in which there are no vacancies at the first location searched for by the searcher 330, the proposer 350 provides information and proposes a change in stopping location to the second location to the user via the HMI 30 when the traveling controller 340 is directing the vehicle M to the first location. In a case in which the proposer 350 has proposed the second location, and the receiver 320 has received a response indicating that the stopping location is to be changed to the second location, the traveling controller 340 directs the vehicle M to the second location. In a case in which the proposer 350 has proposed the second location, and the receiver 320 has not received the response indicating that the stopping location is to be changed to the second location, the traveling controller 340 continues to direct the vehicle M to the first location.

The storage 360 is implemented by various storage devices or an electrically erasable programmable read only memory (EEPROM), a read only memory (ROM), a random access memory (RAM), or the like. The stopping location information 362, the manipulator information 364, a program, and other various kinds of information, for example, are stored in the storage 360.

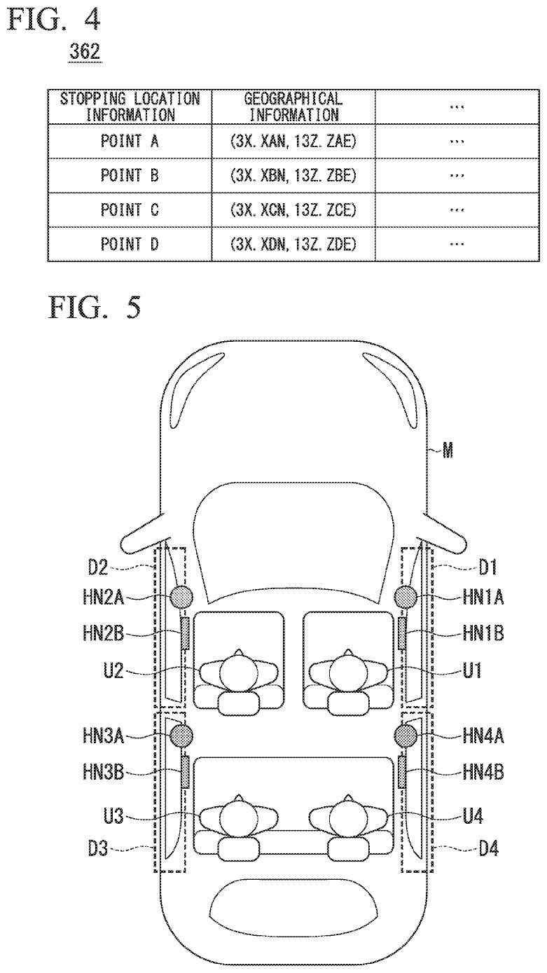

FIG. 4 is an example of information stored in the stopping location information 362. The stopping location information 362 includes, for example, sopping location information, geographical information (for example, information regarding longitudes and latitudes), and the like.

### Manipulator That Receives Stop Request

FIG. 5 is a diagram for explaining a disposition example of the manipulator. In a case in which the vehicle M is a vehicle in which four users can ride, and the users can use mutually different doors D1 to D4, for example, one or more sets of manipulators are associated with each of the doors D1 to D4.

For example, an electronic switch HN1A configured to receive a response regarding a stopping location and an operation regarding opening/closing of the door D1 from a user U1 and a mechanical door handle HN1B configured to receive a manual door opening operation performed by the user U1 are disposed in the surroundings of the door D1. Similarly, an electronic switch HN2A configured to receive a response regarding a stopping location and an operation regarding opening/closing of the door D2 from a user U2 and a mechanical door handle HN2B configured to receive a manual door opening operation performed by the user U2 are disposed in the surroundings of the door D2. Similarly, the door D3 can be opened and closed through an operation of a switch HN3A or a door handle HN3B while the door D4 can be opened and closed through an operation of a switch HN4A or a door handle HN4B.

Each of the doors D1 to D4 may further be provided with a switch and a handle with which opening and closing of the door can be operated from the outside of the vehicle in addition to those in the shown example.

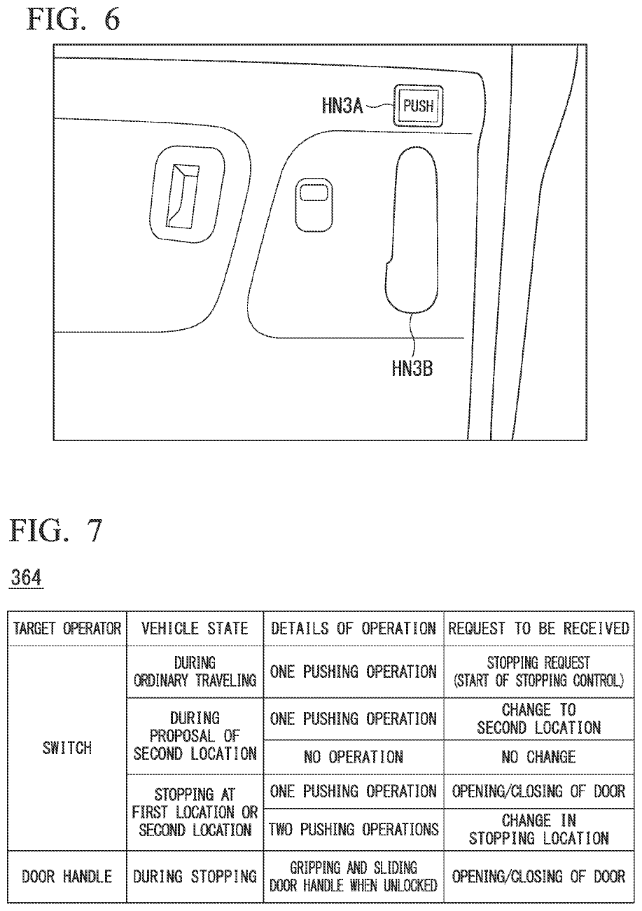

FIG. 6 is a diagram for explaining a disposition example of a manipulator on the door D3. The switch HN3A is, for example, a press button switch. The switch HN3 is a multifunctional switch, operation results of which change in accordance with conditions of the vehicle. In a case in which a user U3 desires to get off the traveling vehicle M, for example, the user U3 requests stopping of the vehicle through an operation of the switch HN3A. In a case in which the user U3 desires to get off the stopped vehicle M, the user U3 requests opening of the door through an operation of the switch HN3A. In a case in which the user U3 desires to get off the stopped vehicle M, the user U3 may manually open the door through an operation of the door handle HN3B. The door handle HN3B can control opening and closing of the door D3 even in a case in which a battery defect or a communication failure occurs in the vehicle M.

It is desirable that the operation performed on the switch HN3A in the case in which the user U3 requests stopping of the vehicle and the operation performed on the switch HN3A in a case in which the user U3 requests opening of the door be the same operation (a simple pushing operation, for example). In this manner, it is not necessary for the user U3 to remember complicated operations, and the user can intuitively provide a stop request, request a change in getting-off location, and perform an operation of opening or closing the door.

FIG. 7 is an example of information stored in the manipulator information 364. In the manipulator information 364, operation targets of the switches HN1A to HN4A or the door handles HN1B to HN4B, states of the vehicle M, operation details, details of requests determined by the receiver 320 are stored.

In a case in which one pushing operation is performed on any of the switches HN1A to HN4A, the receiver 320 changes a request to be received in accordance with the state of the vehicle M at the timing at which the operation is performed, with reference to the manipulator information 364. If one pushing operation is performed on any of the switches HN1A to HN4A in a case in which the vehicle M is traveling, for example, the receiver 320 receives the operation as a stop request from the user. If one pushing operation is performed on any of the switches HN1A to HN4A in a case in which the vehicle M has already received a stop request, and a second location has been proposed by the proposer 350, the receiver 320 receives the operation as a user's request for changing the stopping location from the first location to the second location. If one pushing operation is performed on any of the switches HN1A to HN4A in a case in which the vehicle M is stopping at the first location or the second location, the receiver 320 receives the operation as a user's request for allowing the user to get off the vehicle including a request for opening any of the doors D1 to D4.

In a case in which the user U3 continuously rides in the vehicle M in a state in which the vehicle M is stopping at the first location with the door opened, the user U3 requests for closing the door through one pushing operation on the switch HN3A. In a case in which the user U3 desires to change the stopping location to the second location without opening the door of the vehicle M stopping at the first location (cancellation of the request for allowing the user to get off the vehicle at the first location), the user U3 requests a change in stopping location through two pushing operations on the switch HN3A. The two pushing operations mean that the pushing operation is performed on the switch HN3A twice or more (more specifically, a time during which no pushing is performed needs to be equal to or greater than a predetermined time interval) within a predetermined time. Instead of the two pushing operations, another operation such as long pressing (continuous pushing for a predetermined time or more) may be defined.

The user riding in the vehicle M, which is an automated driving vehicle, can provide an instruction for getting off the vehicle at a desired timing and provide an instruction for changing the stopping location by the manipulator that receives operations regarding the request for allowing the user to get off the vehicle M and the operation regarding a change in stopping location being disposed in the interior of the vehicle M in this manner.

Since the door control device 230 can control opening and closing of the door of the vehicle at a suitable timing through control of the opening and the closing of the door on the basis of a user's operation on the manipulator, it is possible to curb dropping something due to opening of the door at an unexpected timing, contact of the user getting off the vehicle with the door, and stacking of belongings at the door, and it is thus possible for the user to get off the vehicle in more relief.

### Search for Stopping Location

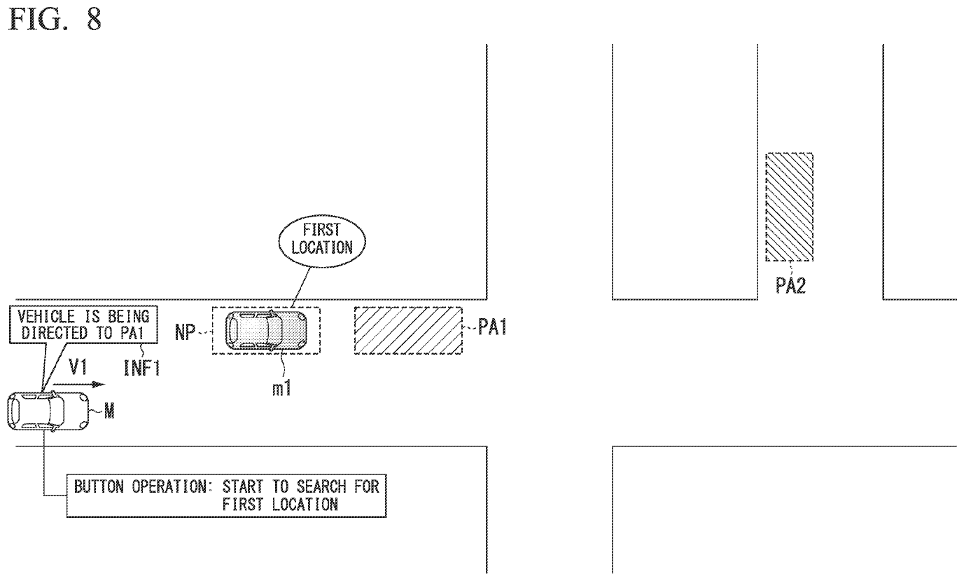

FIG. 8 is a diagram for explaining a first scene. The first scene is a scene in which the vehicle control device 300 of the traveling vehicle M receives a stop request from a user riding in the vehicle. A vehicle speed of the vehicle M before the stop request is received will be referred to as V1.

In a case in which the receiver 320 receives a stop request from the user, the traveling controller 340 decelerates the vehicle from the speed V1. Hereinafter, the decelerated vehicle speed will be referred to as V2.

In a case in which the receiver 320 receives the stop request from the user, the searcher 330 searches for the first location. In a case in which the searcher 330 acquires information regarding a parking frame NP in which another vehicle m1 is stopping and a parking frame PA1 and a parking frame PA2 in a vacant state via the acquirer 310, the searcher 330 selects the parking frame NP as the first location and selects the parking frame PA1 in the vacant state as the second location. Further, the traveling controller 340 directs the vehicle M to the parking frame NP. At this time, the HMI 30 provides, to the user, information indicating that the vehicle M is being directed to the parking frame NP as shown as INF1 in the drawing.

### Proposal of Second Location

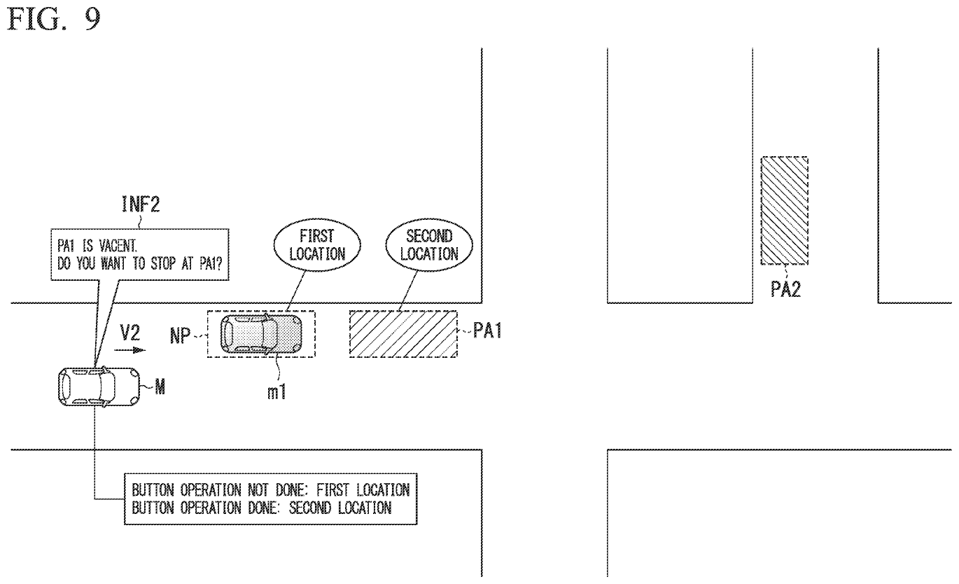

FIG. 9 is a diagram for explaining a second scene. The second scene is a scene after a predetermined time elapses from the first scene and is a scene through which the vehicle control device 300 of the vehicle M that is being directed to the parking frame NP that is the first location proposes the second location to the user riding in the vehicle. In the second scene, the traveling controller 340 directs the vehicle M to the parking frame NP at the vehicle speed V2.

For example, the proposer 350 proposes, as the second location, the parking frame PA1 that is a getting on/off location in the vacant state other than the parking frame NP that is the first location to the user. In that case, the HMI 30 provides, to the user, information indicating that the parking frame PA1 that is the second location can be selected as shown as INF2 in the drawing.

In a case in which the proposer 350 has provided the proposal and the receiver 320 has received a user's response indicating a change in the stopping location to the second location through a button operation, the traveling controller 340 causes the vehicle M to travel toward the parking frame PA1 that is the second location.

On the other hand, in a case in which the proposer 350 has provided the proposal and the receiver 320 has not received the user's response indicating a change in the stopping location to the second location through a button operation, the traveling controller 340 directs the vehicle M to the parking frame NP that is the first location. In a case in which there are no vacancies (or it is estimated that there will be no vacancy) at the first location at the timing at which the vehicle M arrives at the first location, the traveling controller 340 directs the vehicle M to the second location. In this case, information indicating that the getting-off location is to be changed from the first location to the second location since the parking frame NP is not brought into a vacant state is presented to the HMI 30.

Through such control, the vehicle M is directed to the first location even in a case in which the user does not perform any operation regarding whether or not to change the getting-off location to the second location, and it is thus possible to understand the user's intention and to cause the vehicle M to travel without waste of time. In a case in which the user performs an operation for changing the getting-off location to the second location, the vehicle M is directed to the second location, and it is thus possible to understand the user's intention and to cause the vehicle M to travel. In a case in which the operation for changing the getting-off location to the second location has not been received and there are no vacancies at the first location, the vehicle M changes the getting-off location to the second location, and it is thus possible to allow the user to get off the vehicle at a desired location without disturbing a traffic flow in the surroundings of the getting-off location.

Although the proposer 350 may propose the second location only in a case in which the first location is not in the vacant state as shown in the drawing, the proposal may also be performed in a case in which the first location is in the vacant state, and the proposal may be performed as reference information even in the case in which the first location is in the vacant state.

The following description will be given on the assumption that the user has selected the parking frame PA1 that is the second location as a stopping location in the second scene.

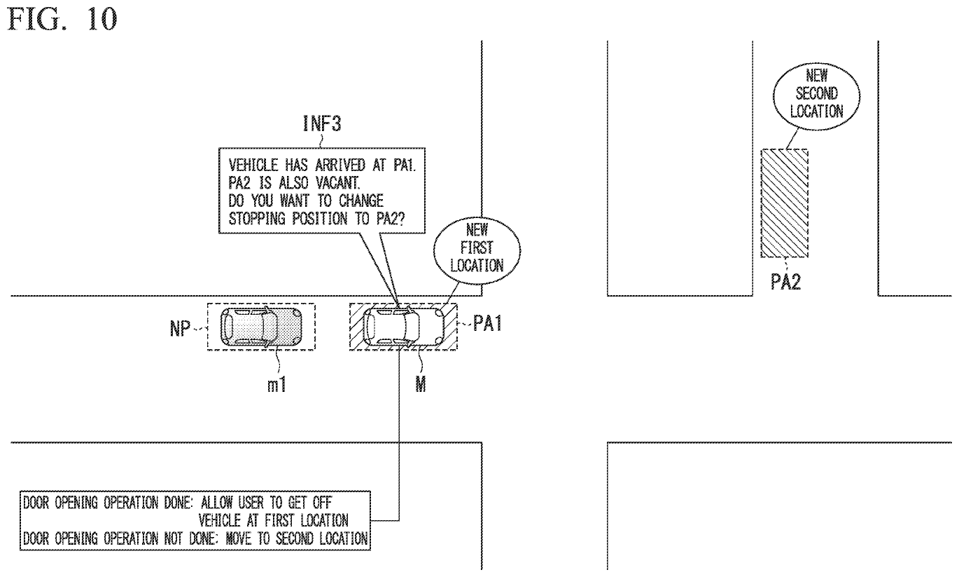

FIG. 10 is a diagram for explaining a third scene. The third scene is a scene after a predetermined time elapses from the second scene and is a scene in which the vehicle M has already passed through the parking frame NP. In the third scene, the traveling controller 340 directs the vehicle M to the parking frame PA1 at the vehicle speed V2. Then the vehicle is stopping. Since the vehicle M has already passed through a location near the parking frame NP, and the user has selected the parking frame PA1 as a stopping location in the second scene, the first location of the vehicle M in the third scene is the parking frame PA1.

### Proposal of Second Location After Stopping

In the third scene, the proposer 350 proposes, as a new second location, the parking frame PA2 that is a getting on/off location in a vacant state other than the parking frame PA1 that is a new first location to the user. In that case, the HMI 30 provides information indicating that the parking frame PA2 that is a new second location can be selected to the user as shown as INF3 in the drawing.

In a case in which an operation received by the receiver 320 in the third scene is a door opening operation, the door control device 230 performs control for opening the target door.

In a case in which the operation received by the receiver 320 in the third scene is not the door opening operation, the traveling controller 340 directs the vehicle M to the second location. In a case in which the user stops getting off the vehicle and performs a door closing operation even after performing the door opening operation in the third scene, the traveling controller 340 may direct the vehicle M to the second location.

### Process Flow

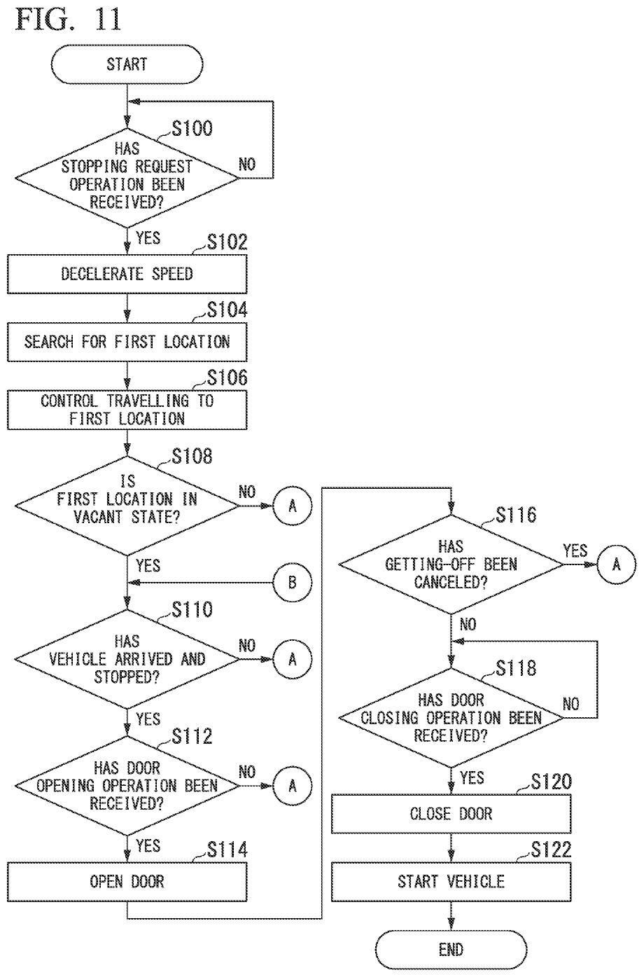

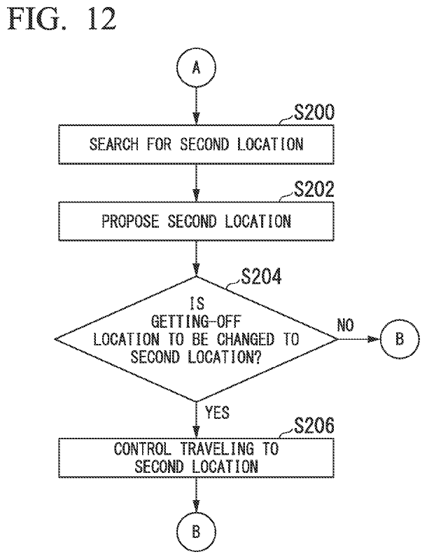

FIGS. 11 and 12 are flowcharts showing an example of a flow of a process performed by the vehicle control device 300 when the user gets off the vehicle. The process in the flowcharts shown in FIGS. 11 and 12 is performed in the process of the traveling of the vehicle M with the user riding therein.

First, the receiver 320 determines whether or not the manipulator has received a user's stop request operation (Step S100). In a case in which it is not determined that the stop request operation has been received, the process in Step S100 is performed again after a predetermined time elapses. In a case in which it is determined that the stop request operation has been received, the traveling controller 340 decelerates the vehicle M (Step S102). Next, the searcher 330 searches for the first location (Step S104). The Processes in Steps S102 and S104 may be performed at the same time, or the process in Step S102 may be performed after the process in Step S104. Next, the traveling controller 340 causes the action plan generator 140 to activate a stopping event and directs the vehicle M to the first location (Step S106).

Next, the searcher 330 determines whether or not the first location is in a vacant state (Step S108). In a case in which it is determined that the first location is in a vacant state, the traveling controller 340 determines whether or not the vehicle M has arrived and stopped at the first location (Step S110). In a case in which it is determined that the vehicle M has arrived and stopped at the first location, the receiver 320 determines whether or not a user's operation to open the door performed on the manipulator has been received (Step S112). In a case in which it is determined that the operation to open the door performed on the manipulator has been received, the door control device 230 performs control to open the target door (Step S114).

The receiver 320 determines whether or not a user's operation to cancel the getting-off at the first location performed on the manipulator has been received (Step S116). In a case in which it is not determined that the operation to cancel the getting-off performed on the manipulator has been received, the receiver 320 determines whether or not an operation to close the door performed on the manipulator by a user who has gotten off the vehicle (or another user riding in the vehicle) has been received (Step S118). In a case in which it is not determined that the operation to close the door has been received, the process in Step S118 is performed again after a predetermined time elapses. In a case in which it is determined that the operation to close the door has been received, the door control device 230 performs control to close the target door (Step S120). Then, the traveling controller 340 causes the vehicle M to start (Step S122).

Moving on to FIG. 12, in a case in which it is not determined that the first location is in a vacant state in Step S108 described above, the searcher 330 searches for the second location (Step S200). Next, the proposer 350 proposes the second location to the user (Step S202). Then, the receiver 320 determines whether or not a user's operation to change the getting-off location to the second location performed on the manipulator has been received (Step S204). In a case in which it is determined that the operation to change the getting-off location to the second location has been received, the traveling controller 340 directs the vehicle M to the second location (Step S206) and returns to the process in Step S110. In a case in which it is not determined that the operation to change the getting-off location to the second location has been received, the traveling controller 340 returns to the process in Step S110.

Similarly, in a case in which it is not determined that the vehicle M has arrived and stopped at the first location in Step S110 described above, the searcher 330 moves on to the process in Step S200. In a case in which it is not determined that the manipulator has received the operation to open the door in Step S112 described above, the searcher 330 moves on to the process in Step S200. In a case in which it is determined that the manipulator has received the operation to cancel the getting-off in Step S116 described above, the searcher 330 moves on to the process in Step S200. The process in the flowchart has been described hitherto.

As described above, the vehicle control device 300 according to the first embodiment can allow the user to get off the vehicle M at a desired location by the receiver 320 receiving a stop request from the user riding in the vehicle M, the traveling controller 340 decelerating the vehicle speed of the vehicle M, the searcher 330 searching for the first location, and the traveling controller 340 directing the vehicle M to the first location.

As described above, the vehicle control device 300 according to the first embodiment can allow the user to smoothly get off the vehicle M at a desired location that is either the first location or the second location by the searcher 330 searching for the second location when the traveling controller 340 directing the vehicle M to the first location and the proposer 350 proposing the second location in a case in which there are no vacancies at the first location.

A change in arrival time may be more preferable than proposal of the second location in a case in which the user has a large luggage, the user is with an infant, the user uses a wheel chair or a cane, or the user is in a poor physical health and there is a specific condition at the first location, for example. Therefore, the proposing process performed by the proposer 350 may be stopped in accordance with attributes and conditions of the user.

### Hardware Configuration

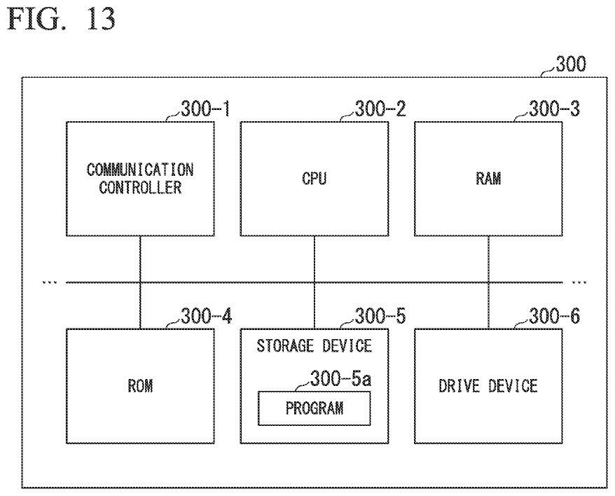

FIG. 13 is a diagram showing an example of a hardware configuration of the vehicle control device 300 according to the first embodiment. As shown in the drawing, each control device is configured such that a communication controller 300-1, a CPU 300-2, a RAM 300-3 used as a working memory, a ROM 300-4 storing a boot program and the like, a storage device 300-5 such as a flash memory and an HDD, a drive device 300-6, and the like are connected to each other via an internal bus or a dedicated communication line. The communication controller 300-1 communicates with components other than the vehicle control device 300. The storage device 300-5 stores a program 300-5a executed by the CPU 300-2. The program is developed by a direct memory access (DMA) controller (not shown) or the like in the RAM 300-3 and is executed by the CPU 300-2. In this manner, part or the entirety of the vehicle control device 300 is implemented.

The vehicle control device according to the embodiment described above can be expressed as follows.

A vehicle control device including: a storage device configured to store a program; and a hardware processor, in which by executing the program stored in the storage device, the hardware processor controls a speed and steering of a vehicle, receives a stop request from a user riding in the vehicle, searches for a first location that is a closest getting on/off location where the user is able to get off the vehicle based on the stop request, and in a case in which the stop request is received, decelerates the speed of the vehicle, searches for the first location, and directs the vehicle to the searched first location.

### Second Embodiment

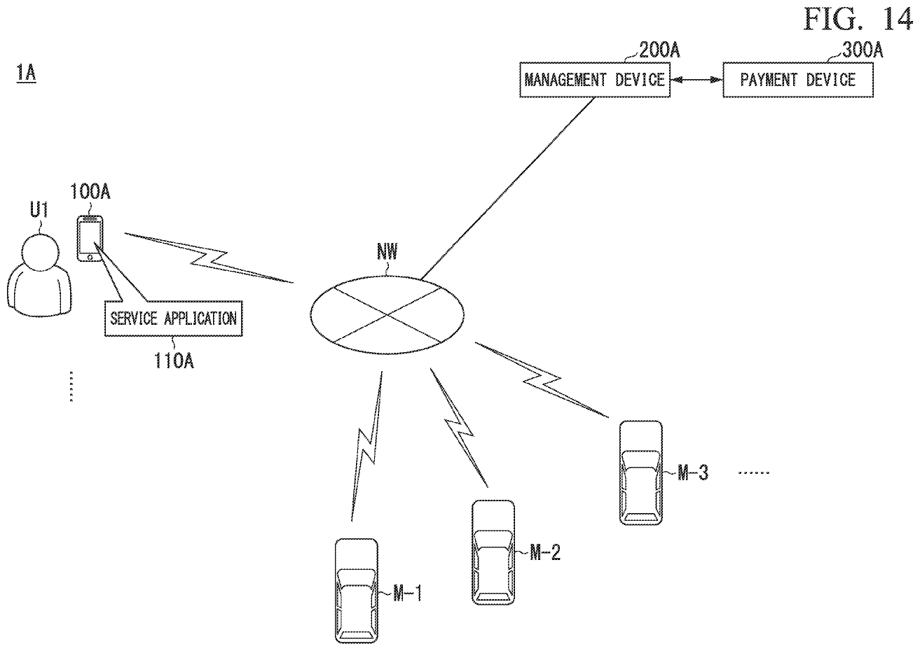

FIG. 14 is a diagram showing an example of a configuration of a vehicle system 1A using the control device. The vehicle system 1A is a system that provides, to the user, a vehicle service that provides a vehicle to the user in response to a user's request. The vehicle takes the user to a destination through automated driving.

The vehicle system 1A includes, for example, one or more vehicles M (the vehicles M1 to M3 . . . in the drawing), one or more terminal devices 100A, a management device 200A, and a payment device 300A. The vehicles M, the terminal devices 100A, and the management device 200A communicate with each other via a network NW, for example. The network NW includes, for example, a cellular network, a Wi-Fi network, Bluetooth (registered trademark), the Internet, a wide area network (WAN), a LAN, a public line, a provider device, a dedicated line, and a wireless base station. The management device 200A is an example of the “control device”.

### Overview of Vehicle Service

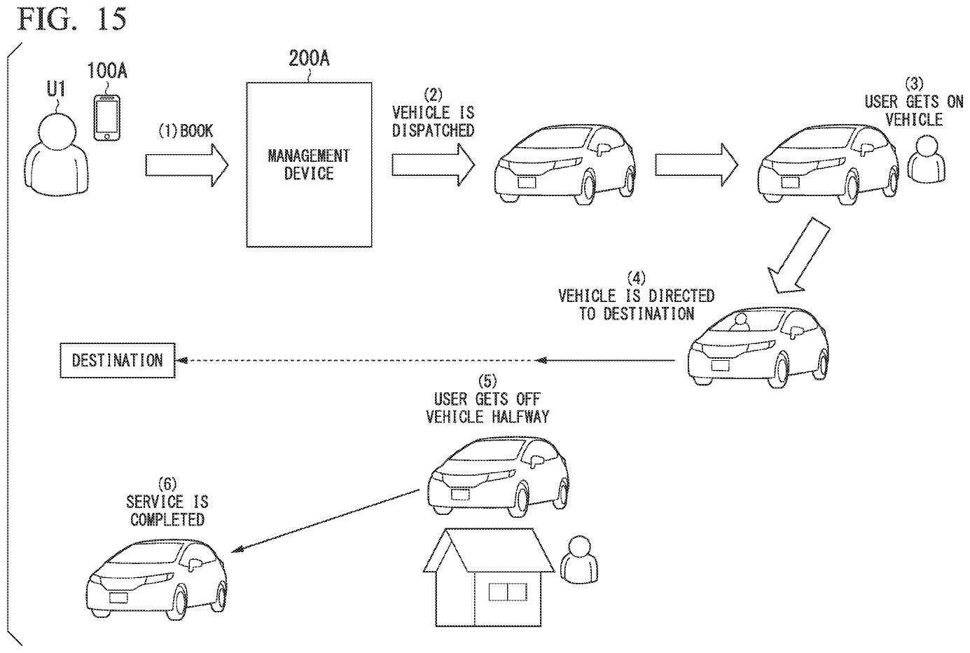

FIG. 15 is a diagram for explaining an overview of the process executed by the vehicle system 1A. First, if the user operates the terminal device 100A to transmit a booking request regarding utilization of the vehicle service to the management device 200A (1), then the management device 200A dispatches the vehicle M to be used for the vehicle service (2). Next, the vehicle M moves in accordance with a utilization start clock time of the vehicle service and is directed to a getting-on position at which the user gets on the vehicle. The user gets on the vehicle M at the getting-on position (3). Then, the vehicle M is directed to a destination of the user with the user riding therein (4). In a case in which the user expresses an intention to get off at an arbitrary location halfway when the vehicle M is on the way to the destination, the vehicle M stops at the arbitrary location. Then, the user gets off the vehicle M (5). If the user gets off the vehicle, the vehicle service for the user is completed, and the vehicle M is directed to a predetermined location (6).

As described above, the user can get off the vehicle at an arbitrary location even on the way to the destination, and convenience for the user is improved.

### Vehicle

The vehicle M is, for example, a vehicle with four or more wheels in which one or more users can ride and may be other vehicles such as a motorcycle. The vehicle M includes equipment for providing the vehicle service in addition to a drive force output device for controlling the vehicle, a brake device, a steering device, and a control device.

The vehicle M is, for example, an automated driving vehicle. The automated driving vehicle is a vehicle that automatically travels to a destination by controlling steering, acceleration, and deceleration without depending on operations of a passenger in the vehicle M. The automated driving vehicle recognizes objects in the surroundings of the vehicle M on the basis of images captured by the camera, results of detection of the radar device, and results of detection of the light detection and ranging (LIDAR), for example. The automated driving vehicle travels to the destination on the basis of results of recognizing objects, the position of the vehicle M, and map information stored in the storage device.

### Terminal Device

The terminal device 100A is a terminal device that the user who uses the vehicle service has. The terminal device 100A is a user's portable terminal device such as a smartphone, a tablet terminal, or a personal computer.

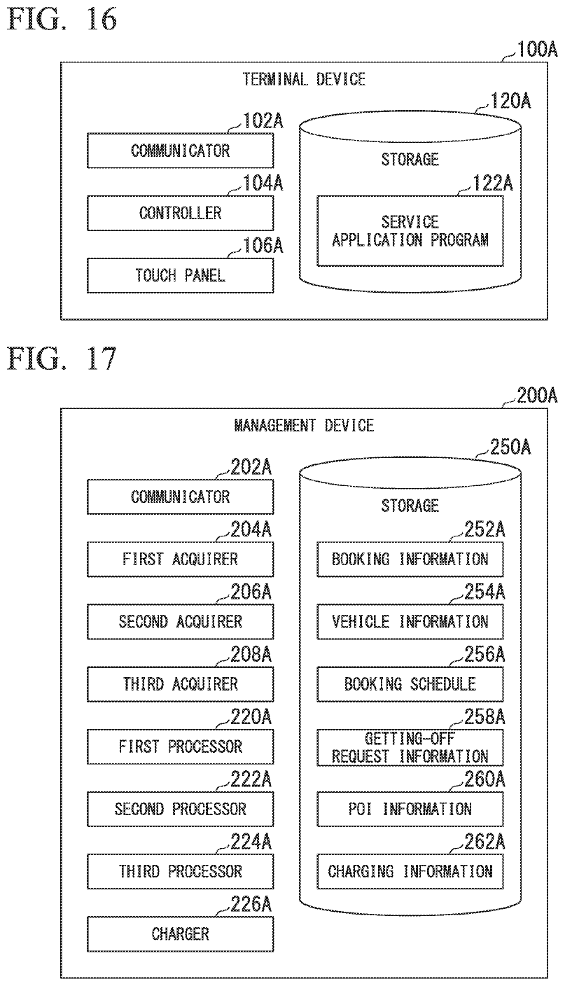

FIG. 16 is a diagram showing an example of a functional configuration of the terminal device 100A. The terminal device 100A includes, for example, a communicator 102A, a controller 104A, a touch panel 106A, and a storage 120A. The communicator 102A is a communication interface for communication with other devices. The controller 104 is implemented by a processor such as a central processing unit (CPU) executing a service application program (software) 122A stored in a storage 150A.

The service application program 122A may be a browser or may be a program having expanded functions as compared with the browser, such as a so-called smartphone application program. The following description will be given on the assumption that the terminal device 100A is a smartphone and the service application program 122A installed in advance in the terminal device 100A is used for a process regarding the vehicle service. The service application program 122A performs communication with the management device 200A in response to a user's operation, transmits a user's request to the management device 200A, and performs a push notification based on information received from the management device 200A.

The touch panel 106A is configured such that a display for displaying information and a receiver for receiving user's operations are superimposed.

### Management Device

FIG. 17 is a diagram showing an example of a functional configuration of the management device 200A. The management device 200A includes, for example, a communicator 202A, a first acquirer 204A, a second acquirer 206A, a third acquirer 208A, a first processor 220A, a second processor 222A, a third processor 224A, a charger 226A, and a storage 250A. The first acquirer 204A, the second acquirer 206A, the third acquirer 208A, the first processor 220A, the second processor 222A, the third processor 224A, and the charger 226A are implemented by a processor such as a CPU executing a program (software) stored in a storage device, for example. Some or all of these functional units may be implemented by hardware such as a large scale integration (LSI), an application specific integrated circuit (ASIC), or a field-programmable gate array (FPGA) or may be implemented by cooperation of software and hardware. Some functional units of the first acquirer 204A to the charger 226A may be included in another functional unit. For example, the first acquirer 204A to the third acquirer 208A may be one acquirer, and the first processor 220A to the third processor 224A may be one acquirer.

The storage 250A stores, for example, booking information 252A, vehicle information 254A, booking schedule 256A, getting-off request information 258A, point of interface (POI) information 260, and charging information 262A.

The communicator 202A is a communication interface for communication with other devices via the network NW. The communicator 202A receives a booking request from the terminal device 100A, for example. The booking request is a request for utilization of a vehicle service.

The first acquirer 204 acquires destination information indicating a destination of the user from the terminal device 100A that the user is able to operate. The destination is a destination to which the user is directed using the vehicle provided by the vehicle service. The second acquirer 206 acquires getting-off request information indicating that the user gets off the vehicle before the vehicle arrives at the destination, from the terminal device 100A that the user is able to operate.

The third acquirer 208A acquires, from the terminal device 100A that the user is able to operate, booking information for booking the user's reboarding of the vehicle after the user gets off the vehicle before the vehicle arrives at the destination.

The third acquirer 208A directs the vehicle with the user riding therein to the destination. Directing the vehicle to the destination means that the first processor 220A provides information indicating the destination of the user to the vehicle M and provides an instruction for directing the vehicle M to the destination.

In a case in which the second acquirer 206 acquires the getting-off request information, the second processor 222A causes the vehicle M to stop before arriving at the destination on the basis of the getting-off request information in order to allow the user to get off the vehicle at an arbitrary location. Causing the vehicle M to stop before arriving at the destination means that the second processor 222A provides information indicating the getting-off position to the vehicle M and provides an instruction for causing the vehicle M to stop at the getting-off position.

The third processor 224A controls the vehicle on the basis of booking information acquired by the third acquirer 208A. In a case in which the booking information is acquired, for example, the third processor 224A directs the vehicle M to a user's designated position included in the booking information, allows the user to get on the vehicle M, and causes the vehicle M to take the user to the destination.

The charger 226A charges the user for a fee on the basis of preset criteria in a case in which the user rides in the vehicle. For example, the charger 226A charges the user for a fee for usage in accordance with user's utilization time of the vehicle M or the riding time of the vehicle M. Then, the charger 226A requests payment of the fee for usage to a payment device 300A. In this manner, the fee for usage is paid to a manager of the vehicle service.

### Payment Device

The payment device 300A is a device that performs payment regarding a fee for usage of the vehicle service in response to a request from the management device 200A. The payment device 300A performs payment by a predetermined payment method. The payment method is, for example, payment using a credit card. The payment method may be an arbitrary payment method such as electronic money payment, bank transfer payment, or payment using a bill for paying the fee for usage at a designated location.

### Sequence (1)

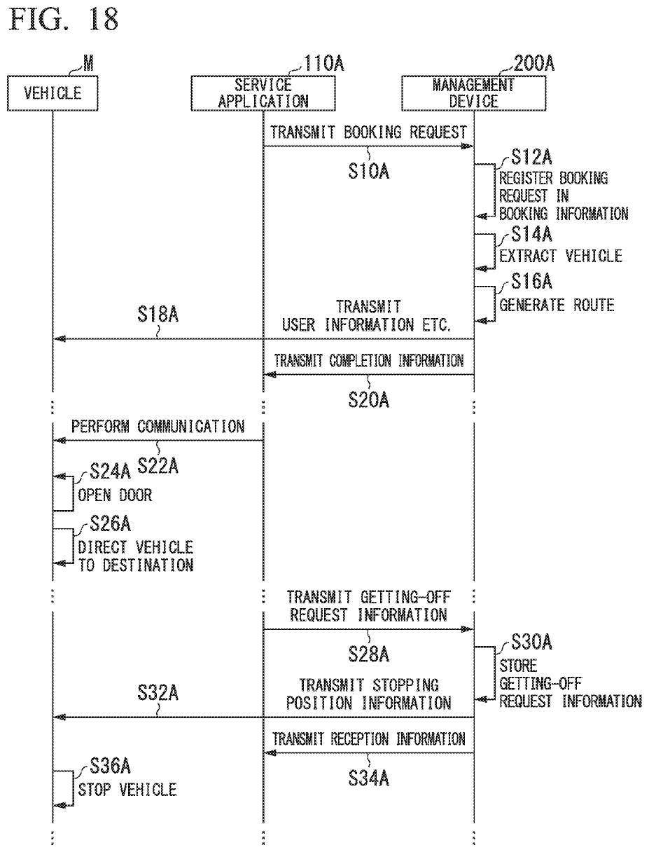

FIG. 18 is a sequence diagram showing an example of a flow of the process executed by the vehicle system 1A. First, the service application 110 of the terminal device 100A transmits a booking request to the management device 200A (Step S10A). If the first acquirer 204 of the management device 200A acquires the booking request, then the first processor 220A registers the booking request in the booking information 252A (Step S12A). The booking information 252A is information including one or more booking requests. The booking request is information in which information such as a time period during which the user desires to use the vehicle, a starting location, a destination (destination information), and utilization is associated with identification of the user.

Next, the first processor 220A extracts an available vehicle with reference to the vehicle information 254A (Step S14A). The vehicle information 254A is information in which position information and a time period (available time) during which the vehicle can be used are associated with identification information of the vehicle. The first processor 220A extracts, from the vehicle information 254A, a vehicle that is located near the start location of the booking request and further, that is available in a time period including a time required to take the user to the destination and a time required to return the vehicle, for example.

Next, the first processor 220A generates a route through which it is possible to efficiently pick up the user and to efficiently take the user to the destination (Step S16A). For example, the route is generated by a Dijkstra's method. The first processor 220A causes the storage 250A to store information in which the generated route, the extracted vehicle, and the booking request are associated as the booking schedule 256A.

Next, the first processor 220A transmits information such as the identification information of the user, the time period of utilization, the starting location, and the destination (hereinafter, referred to as user information) to the vehicle extracted in Step S14A with reference to the booking schedule 256A (Step S18A). Next, the first processor 220A transmits completion information to the service application 110 (Step S20A). The completion information includes a starting location, a starting clock time, identification information of the vehicle, and the like.

Booking of the vehicle is performed as described above. Also, the user can get on the vehicle M as follows.

If the user approaches the vehicle M, performs a predetermined operation on the service application 110, and communicates with the vehicle M, then the service application 110 transmits identification information of the user to the vehicle M (Step S22A). Next, the vehicle M determines whether or not the transmitted identification information conforms to the identification information of the user who is scheduled to get on the vehicle, and in a case in which the transmitted identification conforms to the identification information, the vehicle M controls the door in an opened state (Step S24A). If the user gets on the vehicle M, then the vehicle M travels to the destination of the user (Step S26A). For example, the vehicle M recognizes that the user has gotten on (or gotten off) the vehicle in a case in which getting-on (or getting-off) of the user is recognized on the basis of an image captured by the camera in the interior of the vehicle or the information transmitted by the terminal device 100A and indicating that the getting-on has been completed is acquired.

As described above, the user gets on the vehicle, and the vehicle M is then directed to the destination. Then, the user can get off the vehicle halfway before arriving at the destination as follows.

Next, the user operates the service application 110 to transmit getting-off request information indicating halfway getting-off to the management device 200A (Step S28A). The getting-off request information is information indicating the position at which the user desires to get off the vehicle halfway. Next, the second processor 222A causes the storage 250A to store the transmitted getting-off request information as the getting-off request information 258A (Step S30A).

Next, the second processor 222A transmits stopping position information indicating the stopping position to the vehicle M in order to cause the vehicle M to stop at the position derived on the basis of the getting-off request information 258A (Step S32A). Next, the second processor 222A transmits reception information indicating that the halfway getting-off has been accepted to the service application 110 using the communicator 202A (Step S34A). Then, the vehicle M stops at the position corresponding to the stopping position information transmitted in Step S30A (Step S36A).

After the user gets off the vehicle M at the halfway getting-off position or the destination, the second processor 222A completes the service for the user and controls the vehicle M to provide a service to a user different from the user. Completing the service means, for example, that the second processor 222A completes the vehicle service provided to the user in response to the booking request in Step S10A.

After the user gets off the vehicle M at the halfway getting-off position or the destination, the vehicle M travels to an arbitrary location or waits at an arbitrary location in order to provide a vehicle service to a user different from the aforementioned user, on the basis of an instruction from the management device 200A. In a case in which there is a user who gets on the vehicle M next, for example, the vehicle M travels to a position at which the vehicle M meets the user in order to provide a vehicle service to the user. In a case in which there is no user who gets on the vehicle M next, for example, the vehicle M waits at a predetermined waiting location or returns to a position that is a predefined starting point. In a case in which the vehicle M is an electric vehicle traveling with electric power accumulated in a battery, for example, the vehicle M may wait with a battery charged in a charging facility.

In this manner, it is possible to simplify the process regarding the vehicle M, further to allow the next user to get on the vehicle M without waiting for the user who has gotten off, by the management device 200A completing the service after the user gets off the vehicle M at the getting-off position, thereby to improve utilization efficiency of the vehicle.

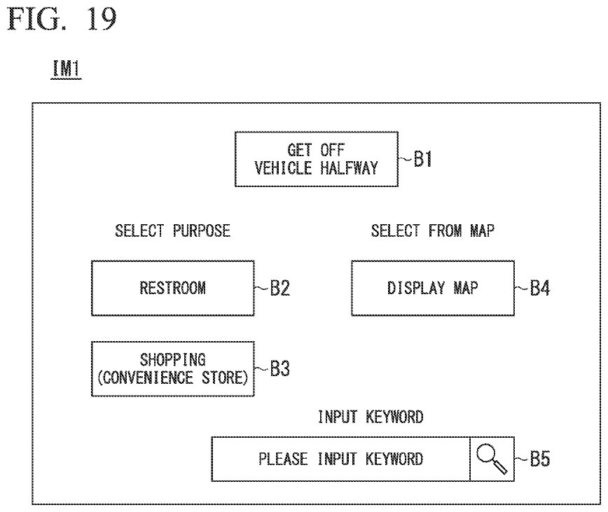

FIG. 19 is a diagram showing an example of an image IM1 displayed by the service application 110 on a touch panel of the terminal device 100A. The image IM1 includes, for example, operation buttons B1 to B5. The operation button B1 is an operation button for providing a halfway getting-off instruction. The operation buttons B2 to B5 are buttons for selecting positions at which the user gets off the vehicle halfway. The operation buttons B2 and B3 are buttons for selecting a halfway getting-off position in accordance with a purpose of the user. The operation button B2 is a button selected when the user gets off the vehicle halfway for the purpose of using a restroom. The operation button B3 is a button selected when the user gets off the vehicle halfway for the purpose of going shopping (for the purpose of dropping by a convenience store, for example).

The operation button B4 is a button for the user selecting a position at which the user gets off the vehicle halfway from the map. The operation button B5 is a button for the user inputting a keyword and selecting POI associated with the input keyword. If the user operates the operation button, then the service application 110 transmits information associated with the operated button to the management device 200A. If the operation button B1 is operated, for example, the service application 110 transmits getting-off request information to the management device 200A.

In a case in which the user desires to get off the vehicle halfway, the user operates the button included in the aforementioned image IM1 to determine the position at which the user gets off the vehicle halfway. The second processor 222A of the management device 200A performs the following process and specifies the getting-off position on the basis of the user's operation.

### Flowchart

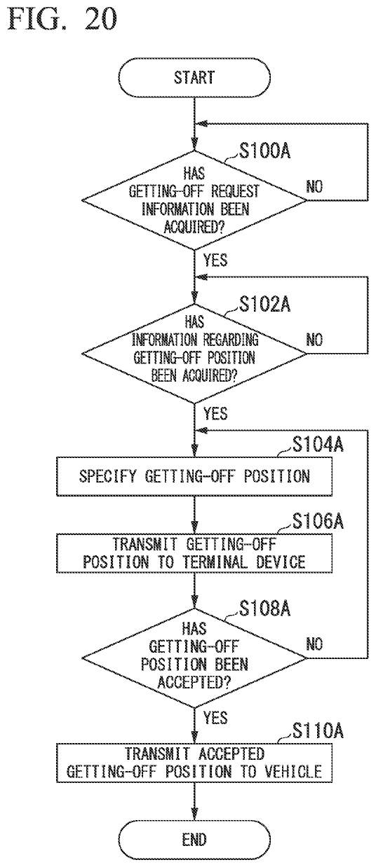

FIG. 20 is a flowchart showing an example of a flow of the process executed by the management device 200A. First, the second processor 222A determines whether or not the second acquirer 206 has acquired getting-off request information (Step S100A). In a case in which the getting-off request information has been acquired, the second processor 222A determines whether or not the second acquirer 206 has acquired information regarding a getting-off position (Step S102A). The information regarding the getting-off position is information indicating that any of the operation buttons B2 to B5 has been operated and information indicating the getting-off position designated by the user through an operation on the terminal device 100A, for example.

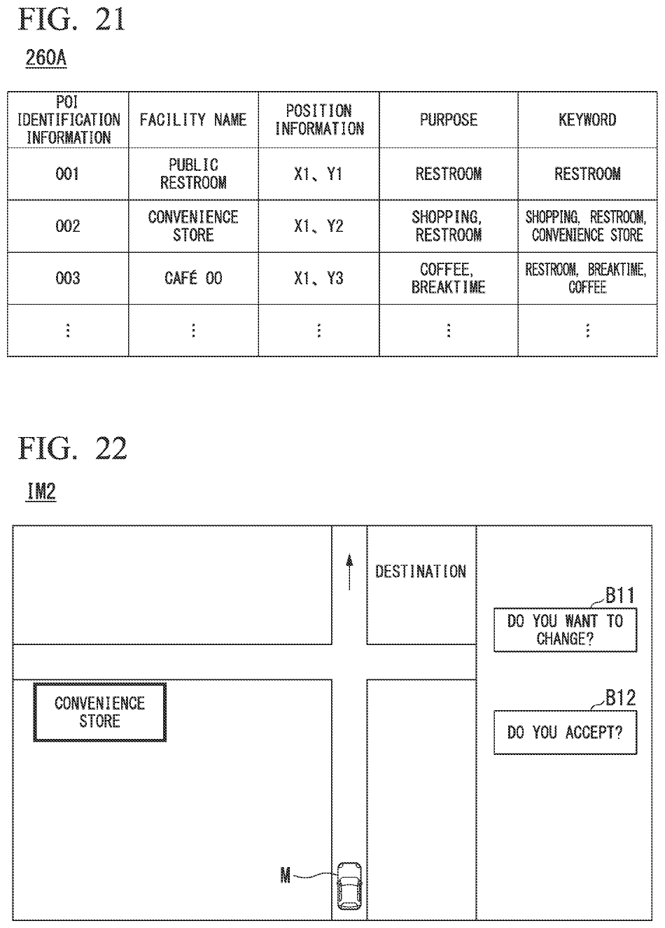

In a case in which the second acquirer 206 has acquired the information regarding the getting-off position, the second processor 222A determines the getting-off position with reference to POI information 260A (Step S104A). FIG. 21 is a diagram showing an example of details of the POI information 260A. The POI information 260A is, for example, information in which facility names, position information, user's purpose of the facilities, and keywords are associated with POI identification information. For example, “purposes: shopping, restroom” and “keywords: shopping, restroom, convenience stores” are associated with convenience stores.

Here, the second processor 222A specifies the getting-off position as follows.

(1) In a case in which the operation button B2 or the operation button B3 is operated, the second processor 222A determines, as the getting-off position, a facility that conforms to the purpose corresponding to the operation button and is located within a predetermined distance from the position of the vehicle M, with reference to POI information 260A. In a case in which the user operates the operation button B3, for example, the second processor 222A determines a convenience store near the vehicle M as the getting-off position.

(2) In a case in which the operation button B4 is operated, the service application 110 causes the touch panel of the terminal device 100A to display a map. In the map, facility names are associated with facility positions. If the user performs a touch operation on an icon indicating a facility associated with the map displayed on the touch panel, the service application 110 transmits identification information of the facility to the management device 200A. The second processor 222A specifies the facility on the basis of the transmitted identification information of the facility and the POI information 260A and determines the position of the specified facility as the getting-off position.

(3) In a case in which a keyword has been input to the operation button B5, and an operation for searching for the keyword has been performed, the service application 110 transmits the keyword to the management device 200A. If the second acquirer 206 acquires the keyword, the second processor 222A determines, as the getting-off position, a facility that corresponds to the keyword and is located within a predetermined distance from the position of the vehicle M, with reference to the POI information 260A. In a case in which the user designates a convenience store as a keyword, for example, the second processor 222A determines a convenience store near the vehicle M as the getting-off position.

Returning to the description of FIG. 20, the second processor 222A transmits the determined getting-off position to the terminal device 100A (Step S106A). Next, the second processor 222A determines whether or not the user has accepted the getting-off position (Step S108A). In a case in which the user has accepted the getting-off position, the second processor 222A transmits the accepted getting-off position to the vehicle M using the communicator 202A (Step S110A). In a case in which the user has not accepted the getting-off position, the process returns to Step S104A, and the second processor 222A determines a getting-off position that is different from the determined getting-off position. The different getting-off position is a facility that is present at a position far from the facility previously determined as the getting-off position. In this manner, one routine of process in the flowchart is ended.

FIG. 22 is a diagram showing an example of an image IM2 representing a getting-off position displayed on the touch panel. The image IM2 includes, for example, information in which the position of the vehicle M and the getting-off position (the position of the convenience store) are associated with map information, an operation button B11, and an operation button B12. The operation button B11 is a button for transmitting information indicating that the facility determined as the getting-off position is not accepted to the management device 200A. In a case in which the operation button B11 is operated, a facility that is different from the convenience store in the image IM2 is determined as a getting-off position, and information in which the determined getting-off position and the map information are associated is displayed on the touch panel.

The operation button B12 is a button for transmitting information indicating that the facility determined as the getting-off position is accepted to the management device 200A. In a case in which the operation button B12 is operated, the vehicle M stops at the getting-off position, and the user can get off the vehicle at the getting-off position.

### Sequence (2)

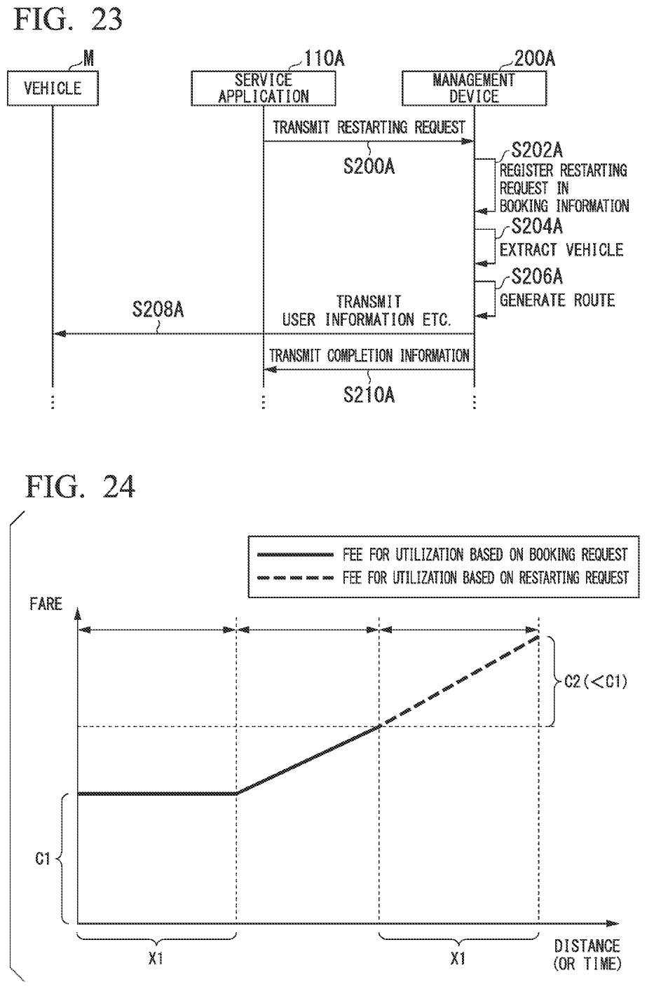

For example, it is assumed that after the user gets off of the vehicle, the vehicle M has started to travel to another position in order to allow another user to get on the vehicle M. In a case in which the user ends what to do at the facility at the getting-off position and desires to use the vehicle service again, the following process is performed. FIG. 23 is a sequence diagram showing an example of a flow of the process executed by the vehicle system 1A.

First, the service application 110 transmits a restarting request to the management device 200A (Step S200A). The restarting request is a booking request transmitted by the user who has gotten off the vehicle before arriving at the destination within a predetermined time after getting off the vehicle at the getting-off position. When the user transmits the booking request within the predetermined time after getting off the vehicle at the getting-off position, the service application 110 converts the booking request into a restarting request and transmits the restarting request to the management device 200A. In a case in which the acquired booking request is the booking request transmitted within the predetermined time after the user gets off the vehicle at the getting-off position, the management device 200A may determine that the booking request is a restarting request. The restarting request is information in which information such as a time period during which the user desires to use a vehicle, a starting location, a destination, and utilization is associated with identification information of the user.

Next, if the first acquirer 204A of the management device 200A acquires the restarting request, then the first processor 220A stores the restarting request in the booking information 252A (Step S202A).

Next, the third processor 224A extracts an available vehicle with reference to the vehicle information 254A (Step S204A). Next, the third processor 224A generates a route through which it is possible to efficiently pick up the user and to efficiently take the user to the destination (Step S206A).

Next, the third processor 224A transmits, to the vehicle extracted in Step S204A, information (hereinafter, referred to as user information) such as the identification information of the user, the utilization time period, the starting location, and the destination with reference to the booking schedule 256A (Step S208A). Next, the third processor 224A transmits completion information to the service application 110 (Step S210A). In the aforementioned process, the dispatched vehicle may be a vehicle that is different from the vehicle M in which the user rides to the getting-off position or may be the vehicle M in which the user rides to the getting-off position. For example, the third processor 224A dispatches the vehicle M that can arrive at the position designated by the user quickly and at low cost.

As described above, the third acquirer 208A acquires the booking information for booking a user's reboarding of the vehicle M after the user gets off the vehicle at an arbitrary location from the terminal device 100A that the user is able to operate. The third processor 224A controls the vehicle M on the basis of the booking information acquired by the third acquirer 208A. In this manner, the user can get on the vehicle M at the position at which the user gets off halfway.

### Process of Charger

The charger 226A charges the user for a fee for usage on the basis of the following idea. The charger 226A charges the user for a starting fare in a case in which the user uses a vehicle service on the basis of a booking request, and the charger 226A charges the user with a trend that the fare increases with an increase in distance or time in a case in which the user uses the vehicle service for a distance or a time exceeding those defined for the starting fare.

FIG. 24 is a diagram showing an example of a trend of the fee for usage to be charged. The vertical axis in FIG. 24 represents a price to be charged, and the horizontal axis in FIG. 24 represents a time during which the user rides in the vehicle (a time during which the user uses the vehicle).

Further, in a case in which the user uses the vehicle service on the basis of a restarting request, the charger 226A reduces the fee for usage as compared with a case in which the user uses the vehicle service on the basis of the booking request. As shown in FIG. 24, the fee for usage is a starting fare C1 in a case in which the vehicle travels by a distance X1 in response to a booking request, and the fee for usage is a fee for usage C2 in a case in which the vehicle travels by the distance X1 in response to a restarting request. The fee for usage C2 is a price lower than the starting fare C1. In a case in which the user uses the vehicle M on the basis of the restarting request, for example, a price system that is equivalent to that added after the starting fare or a price system with a reduced fee for usage as compared with the price system is employed.

In this manner, the fee for usage is reduced in a case in which the user gets off the vehicle at the getting-off position before arriving at the destination and uses the vehicle service again, convenience for the user is improved.

In a case in which the user gets off the vehicle at an arbitrary location before arriving at the destination, the charger 226A may not charge the user for any fee for the getting-off at the arbitrary location. In other words, the charger 226A does not charge the user for the penalty. In this case, the charger 226A charges the user for the fare to the arbitrary position. As a result, the user can casually use the vehicle.

According to the second embodiment described above, it is possible to improve convenience for the user after the user gets on the vehicle M by the management device 200A causing the vehicle M to stop before arriving at the destination to allow the user to get off the vehicle at an arbitrary location in response to acquisition of the getting-off request information.

### Third Embodiment

Hereinafter, a third embodiment will be described. In the third embodiment, in a case in which the user performs a predetermined operation, the vehicle M stops at a position in accordance with the operation. Hereinafter, the third embodiment will be described.

In a case in which an urgent getting-off button is operated, the third processor 224A directs a vehicle M to a specific location with reference to POI information. The urgent getting-off button is a button caused to be displayed on the touch panel by the service application 110 in response to an operation of the user.

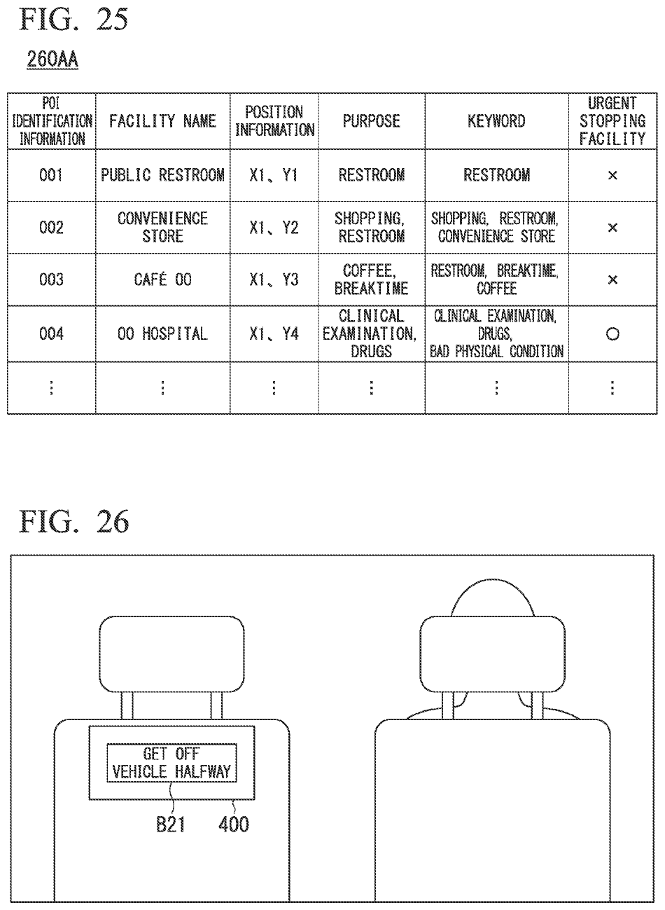

FIG. 25 is a diagram showing an example of details of POI information 260AA. The POI information is information in which information indicating whether or not a facility is an urgent stopping facility is associated with POI identification information, in addition to the details of the POI information 260A in the first embodiment. In the example in FIG. 25, a hospital is an urgent stopping facility.

In a case in which physical health of the user riding in the vehicle M becomes poor, and the user operates the urgent stopping button, for example, the service application 110 transmits urgent information indicating that the urgent stopping button has been operated to the management device 200A. If the management device 200A acquires the urgent information, then the third processor 224A extracts an urgent stopping facility that is present near the vehicle M with reference to POI information 260AA and directs the vehicle M to the extracted urgent stopping facility.

In this manner, the user is automatically transported to the urgent stopping facility and can be treated at the urgent stopping facility. In a case in which the urgent stopping button is operated, the management device 200A may transmit, to (a device managed by) the urgent stopping facility, information indicating that the user is to be transported to the extracted urgent stopping facility and identification information of the vehicle that is transporting the user.

According to the third embodiment described above, it is possible to improve convenience for the user after the user gets on the vehicle by the management device 200A further including the third acquirer 208A configured to acquire the urgent getting-off request information for the user to provide an urgent getting-of instruction from the terminal device 100A that the user is able to operate and the third processor 224A configured to cause the vehicle with the user riding therein to stop at a specific location associated with the urgent instruction information acquired by the third acquirer 208A.

### Fourth Embodiment

Hereinafter, a fourth embodiment will be described. In the second and third embodiments, it is assumed that a user uses a vehicle service through an operation on a portable terminal device 100A. In the third embodiment, the user uses the vehicle service through an operation on the terminal device 100AA provided in the vehicle M. Hereinafter, differences from the second and third embodiments will mainly be described.

FIG. 26 is a diagram showing an example of a condition of the interior of the vehicle M. FIG. 26 is a view when the user seated in a rear seat sees the front side of the vehicle M. A touch panel 400 is provided on the rear side of a front passenger seat of the vehicle M. An operation button B21 is displayed on the touch panel 400 after the user gets on the vehicle M. If the operation button B21 is operated, the vehicle M stops at a getting-off position.

Operation buttons B12 to B15 may be displayed on the touch panel 400. The user may determine the getting-off position through an operation on the operation buttons B12 to B15.

According to the fourth embodiment described above, the management device 200A has similar effects to those in the second or third embodiment.

Each of the aforementioned embodiments has been described on the assumption that the management device 200A is provided separately from the vehicle M. Instead, some or all of the functional configurations of the management device 200A may be provided in the vehicle M or in the terminal device 100A (or 100AA). For example, some or all of the second acquirer 206A, the third acquirer 208A, the second processor 222A, the third processor 224A, the getting-off request information 258A, the POI information 260A, and the charging information 262A of the management device 200A may be included in the vehicle M or the terminal device 100A (or 100AA).

### Hardware Configuration

The management device 200 is configured such that a communication controller, a CPU, a random access memory (RAM) used as a working memory, a read only memory that stores a boot program, a storage device such as a flash memory and a hard disk drive (HDD), a drive device, and the like are connected to each other via an internal bus or a dedicated communication line as shown in FIG. 13 described above. The communication controller performs communication with components other than the management device. The storage device stores a program that the CPU executes. The program is developed by a direct memory access (DMA) controller (not shown) or the like in the RAM and is executed by the CPU. In this manner, some or all of the first acquirer 204 to the charger 226 are implemented.

The embodiments described above can be expressed as follows.

An information providing device including: a storage device configured to store a program; and a hardware processor,

wherein by the hardware processor executing the program stored in the storage device, the information providing device acquires destination information indicating a destination of a user from a terminal device that the user is able to operate, directs a vehicle with the user riding therein to the destination, acquires getting-off request information for a request for getting off the vehicle before the vehicle arrives at the destination from the terminal device that the user is able to operate, and in a case in which the getting-off request information is acquired, causes the vehicle to stop before the vehicle arrives at the destination on the basis of the getting-off request information.

Although the embodiments for implementing the present invention have been described hitherto, the present invention is not limited to such embodiments, and various modifications and replacements can be added without departing from the gist of the present invention.

What is claimed is:

1. A control device comprising:
a traveling controller configured to control a speed and steering of a vehicle;
a receiver configured to receive a stop request from a user riding in the vehicle; and
a searcher configured to search for a first location that is a closest getting on/off location where the user is able to get off the vehicle, based on the stop request,
wherein in a case in which the receiver receives a stop request,
the traveling controller decelerates the speed of the vehicle, the searcher searches for the first location, and then,
the traveling controller directs the vehicle to the first location searched for by the searcher.

2. The control device according to claim 1,
wherein the searcher searches for a second location that is a getting on/off location other than the first location in a case in which there are no vacancies at the searched first location, and
the traveling controller directs the vehicle to the second location searched for by the searcher.

3. The control device according to claim 2, further comprising:
a proposer configured to propose, to the user, a change in stopping location to the second location when the traveling controller directs the vehicle to the first location in the case in which there are no vacancies at the searched first location.

4. The control device according to claim 3, wherein the traveling controller directs the vehicle to the second location in a case in which the receiver receives, from the user, a response indicating that the stopping location is to be changed to the second location.

5. The control device according to claim 3, wherein the traveling controller directs the vehicle to the second location in a case in which the receiver does not receive, from the user, a response indicating that the stopping location is to be changed to the second location and there are no vacancies at the first location.

6. The control device according to claim 5,
wherein the searcher continues to search for the second location until the vehicle arrives at the first location, and
in a case in which the vehicle arrives at the first location, the receiver receives, from the user, either a response indicating that the user is to get off the vehicle at the first location or a response indicating that the stopping location is to be changed to the second location.

7. The control device according to claim 1, further comprising:
a door controller configured to control at least opening of a door of the vehicle based on a result of an operation performed by the user on a manipulator,
wherein the manipulator is the same as a manipulator through which the receiver receives the stop request, and
in a case in which the vehicle arrives at the stopping location and the receiver receives an operation indicating that the user is to get off the vehicle performed by the user on the manipulator, the door controller opens the door of the vehicle.

8. The control device according to claim 7,
wherein the door controller further controls closing of the door of the vehicle, and
in a case in which the receiver receives an operation performed by the user on the manipulator in a state in which the door is opened, the door controller closes the door of the vehicle.

9. The control device according to claim 7,
wherein the manipulator is one or more electronic switches provided in the vehicle and configured to receive a response regarding the stopping location and an operation regarding opening/closing of the door from the user,
a mechanical door handle configured to receive a manual door opening operation performed by the user is included in the manipulator, and
the door controller controls opening of the door of the vehicle based on the operation performed by the user on the switch.

10. A vehicle control method comprising, by a computer:
controlling a speed and steering of a vehicle;
receiving a stop request from a user riding in the vehicle;
searching for a first location that is a closest getting on/off location where the user is able to get off the vehicle based on the stop request; and
in a case in which the stop request is received,
decelerating the speed of the vehicle and searching for the first location; and
directing the vehicle to the searched first location.

11. A control device comprising:
a first acquirer configured to acquire destination information indicating a destination of a user from a terminal device that the user is able to operate;
a first processor configured to direct the vehicle with the user riding therein to the destination;
a second acquirer configured to acquire, from a terminal device that the user is able to operate, getting-off request information for a request for getting off the vehicle before the vehicle arrives at the destination; and
a second processor configured to stop the vehicle before the vehicle arrives at the destination based on the getting-off request information in a case in which the second acquirer acquires the getting-off request information.

12. The control device according to claim 11, wherein the terminal device that the user is able to operate is a terminal device that the user brings with himself/herself or a terminal device provided in the vehicle.

13. The control device according to claim 11, wherein in a case in which the user gets off the vehicle at the destination or before the vehicle arrives at the destination, the second processor controls the vehicle to complete a service for the user and provide a service to a user different from the user.

14. The control device according to claim 11, further comprising:
a third acquirer configured to acquire, from the terminal device that the user is able to operate, booking information for booking the user's reboarding of the vehicle after the user gets off the vehicle before the vehicle arrives at the destination; and
a third processor configured to control the vehicle based on the booking information acquired by the third acquirer.

15. The control device according to claim 14, wherein the third processor dispatches a vehicle that is different from the vehicle in which the user has ridden, based on the booking information.

16. The control device according to claim 11, further comprising:
a third acquirer configured to acquire, from the terminal device that the user is able to operate, urgent getting-off request information for an urgent getting-off instruction from the user; and
a third processor configured to cause the vehicle with the user riding therein to stop at a specific location associated with the urgent instruction information acquired by the third acquirer.

17. The control device according to claim 11, further comprising:
a charger configured to charge the user for the riding in the vehicle based on preset criteria in a case in which the user rides in the vehicle,
wherein in a case in which the user gets off the vehicle before the vehicle arrives at the destination, the charger does not charge the user for any fee for the getting-off.

18. A control method comprising, by a computer:
acquiring destination information indicating a destination of a user from a terminal device that the user is able to operate;
directing a vehicle with the user riding therein to the destination;
acquiring getting-off request information for a request for getting-off the vehicle before the vehicle arrives at the destination from a terminal device that the user is able to operate; and
in a case in which the getting-off request information is acquired, causing the vehicle to stop before the vehicle arrives at the destination based on the getting-off request information.
